(19) United States
(12) Patent Application Publication
(10) Pub. No.: US 2026/0056713 A1
(43) Pub. Date: Feb. 26, 2026

(54) SCOPE-BASED SOURCE CODE AUTOSUGGESTION WITH OBJECT BEHAVIORAL PROPERTY DETECTION

(71) Applicant: Zoho Corporation Private Limited, Kanchipuram District (IN)

(72) Inventors: Pradeep Kumar Duraisamy Soundrapandian, Sivakasi (IN); Punithavathi Palani, Chennai (IN); Subathra Periakaruppan, Madurai (IN); Sridhar Vembu, Tenkasi (IN); Joseph Sathya Kumar, Chennai (IN); Akshhayaa S, Guduvanchery (IN); Sudheer A. Grandhi, Pleasanton, CA (US)

(73) Assignee: Zoho Corporation Private Limited, Kanchipuram District (IN)

(21) Appl. No.: 19/180,247

(22) Filed: Apr. 16, 2025

Related U.S. Application Data
(60) Provisional application No. 63/655,014, filed on Jun. 2, 2024.

(30) Foreign Application Priority Data
Apr. 19, 2024 (IN) 202441031377

(51) Int. Cl. G06F 8/30

(52) U.S. Cl. CPC G06F 8/30

(57) ABSTRACT

A system providing scope-based source code autosuggestion, with object behavioral property detection and automated template generation is disclosed. Constructs are identified in source code in one or more files. Characters are input at a location. Constructs matching the characters and within the location scope, based on surrounding code structure, are placed in a list. The list of scope-matched constructs are output to the user in real-time, and the characters may be auto-completed responsive to a user selection. The constructs identified may be limited to those contextually relevant to current scope, such as within the same function, class, or namespace. Code templates may be located, adapted to the construct, and displayed for auto-completion. The user may select one of the list items for insertion into the source code. The scope-matched constructs are updated in real-time responsive to user input, dynamically refining the list.

### FIELD OF THE INVENTION

Embodiments of the present disclosure are related, in general, to computer programming languages and more particularly, but not exclusively, to auto-suggestion in software development environments.

### CROSS REFERENCE TO RELATED APPLICATIONS

This application is related to Indian Provisional Application 20/244,1031377 filed 19 Apr. 2024 and U.S. Patent Application Ser. No. 63/655,014 filed 2 Jun. 2024, both entitled “INTEGRATED DEVELOPMENT ENVIRONMENT (IDE) WITH SCOPE-BASED OBJECT BEHAVIORAL PROPERTY DETECTION TECHNIQUE”, and which are incorporated herein by reference.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 is a distributed Integrated Development Environment (IDE) 100 including user terminal 104a operated by user 102a.

FIG. 2A is a flowchart 200 illustrating a method of scope-based autosuggestion.

FIG. 2B illustrates an example list generation process 230.

FIG. 2C is flowchart 200 modified to further provide scope-based information or

reminder elements.

FIG. 3A illustrates source code 120 being divided into regions with defined visibility scopes using scope in accordance with semantic and syntactic requirements of the programming language.

FIG. 3B illustrates region boundaries delineating the regions R1-R10 and illustrates updating the source code and region boundaries in response to the insertion of new code.

FIG. 4 illustrates a conceptualized Abstract Syntax Tree (AST) 400 including region boundaries.

FIG. 5A is visibility scope data structure 510.

FIG. 5B illustrates visibility scope data structure 510 using the example source code 120 of FIGS. 3A-B.

FIG. 6 is an embodiment of an IDE 100 using the visibility scope data structure 510 in lookup module 180, and illustrating the use of an AST 400, type tree 630, and code templates 640 with list generator 150.

FIG. 7 details an exemplary embodiment of type tree 630 and source code templates 640 in an IDE 100.

FIG. 8 is an example IDE 100 comprising a type tree 630 and source code templates 640 as applied to the example code snippet above.

FIGS. 9A-C illustrate an example process 230 for list generation 150.

FIGS. 10A-D include various pseudocode snippets illustrating source code 120 with associated auto-suggestions to illustrate scope-matching and list generation using the example of FIG. 9.

FIGS. 10E-G include various pseudocode snippets illustrating source code 120 with associated reminder prompts.

FIG. 11 illustrates a local IDE environment 106 interacting with project server 1190 in a distributed IDE environment.

FIG. 12 illustrates an example embodiment of distributed IDE 100 including components of a user terminal 104 and a project server 1190.

### DETAILED DESCRIPTION

Modern Integrated Development Environments (IDEs) and compiler systems are sophisticated tools that have revolutionized the way developers create, test, and deploy software. They are designed to streamline the development process, making it more efficient and less error prone.

An IDE is a software suite that consolidates the basic tools needed to write and test software. Modern IDEs come with a source-code editor, build-automation tools, and a debugger. Some also include features like intelligent code completion, syntax highlighting, and code refactoring, which help developers write clean, efficient code. They often support multiple programming languages and provide a unified interface for developers to write, compile, debug, and run their code.

One of the defining characteristics of modern IDEs is their extensibility. They often come with plugin systems that allow developers to add new features or support for additional programming languages. This extensibility makes them adaptable to a wide range of development needs. Furthermore, many IDEs offer cloud-based versions, enabling developers to work from anywhere and collaborate with others in real-time.

At the source code level, user-defined functions and types pertain to structures, classes, interfaces, and other composite data types that programmers define to represent and manipulate complex data structures more effectively. These types go beyond the basic data types like int, float, and char that most languages offer inherently. User-defined types allow for the encapsulation of data and related functionality into cohesive units.

Auto-suggestion in source code editors is a feature that assists developers by automatically suggesting code completions as they type. This functionality is often powered by parsing the current file, analyzing its syntax and structure, and utilizing additional information from related files, libraries, or APIs. As the developer writes code, the editor suggests variables, functions, classes, methods, and even snippets of commonly used patterns that are relevant to the current context. This feature not only speeds up the coding process but also helps reduce errors by suggesting syntactically correct and contextually appropriate options.

A regular expression (often abbreviated as regex or regexp) is a sequence of characters that forms a search pattern, primarily used for string matching or manipulation. Regular expressions are a powerful tool for searching, matching, and manipulating text based on specific patterns. They are widely used in programming, text processing, and data validation, as well as auto-suggestion.

Modern IDEs and code editors like Visual Studio Code, IntelliJ IDEA, and others integrate auto-suggestion engines that can recognize coding patterns, provide intelligent completion, and even offer documentation alongside suggestions. For example, when a developer begins typing the name of a function or a method, the editor can list all available functions, as well as their parameters and return types. Auto-suggestion improves code accuracy and efficiency and is particularly useful for large codebases or when working with complex frameworks or libraries. By reducing the amount of code the developer needs to manually type, it allows for faster and more focused coding, while minimizing syntax and spelling errors.

While existing IDEs and code editors facilitate improved code editing, they suffer from several shortcomings. Often limited to simple file-level regex, they may not provide access to a wide enough scope of functions, variables, objects, and others. They can suggest unnecessary code that is not accessible semantically according to the programming language while at the same time fail to present object elements and expressions that would be desirable.

In programming languages, types represent categories of data, such as integers, floating-point numbers, strings, or user-defined types like classes and structures. Functions are blocks of code designed to perform specific tasks or calculations, operating on input data. A function typically takes one or more arguments, processes them, and returns a result.

An object is an instance of a type and contains elements or properties, also referred to as fields or attributes in some languages and can exhibit certain behaviors. These behaviors are defined by methods or functions that operate on the object's data. For example, in object-oriented programming (OOP), a class Person might represent a type, and an object john of type Person may have attributes like name and age, and methods like speak( ) or walk( ) Developers interact with objects by accessing and modifying their elements (e.g., john.name=“John”) and invoking methods that change or read the object's state (e.g., john.speak( ). Or consider an object representing a car. The car object may have behavioral properties like “startEngine( )”, “accelerate( )”, “stopEngine”, “turnLightsOn”, “turnLightsOff”, “applyBrake” and others. The method also outlines how the interaction with the external environment or with the other objects can be performed.

A type definition may also include other types of elements or properties. A computed property, also referred to as a computed entity, is an element of a type defined using an expression. The value of the computed property is calculated from the expression, which may be a function of one or more other elements. A user-defined Behavioral Property (BP) is a programming construct defined as an element of a type to ensure instances or objects of the type conform to an expression constraint. The value of the BP after evaluating the expression constraint can vary. Examples include a Boolean, error, string or number. The BP is automatically reevaluated whenever components of its expression constraint are modified.

Scope refers to the visibility and lifetime of variables, functions, and objects and their elements and behavioral properties in different parts of a program. There are typically three main types of scope: local, global, and block scope. Local scope pertains to variables or objects declared within a function, meaning they can only be accessed from inside that function. Global scope refers to variables or functions declared outside of all functions and accessible throughout the entire program. Block scope applies to code, like loops or conditional statements, often within delimiters such as curly braces ({ }), where variables and others are only accessible inside that block. To interact with functions or objects outside of the current scope, developers must either pass them explicitly as arguments, declare them in a higher scope (such as global), or use mechanisms like closures in languages that support them.

A system providing scope-based source code autosuggestion, with object behavioral property detection and automated template generation is disclosed. The system, such as an integrated development environment (IDE) comprises a processing unit configured to receive source code in one or more source code files. A parser module in communication with the processing unit parses the received source code files to identify constructs within the source code. The constructs include but are not limited to variables, functions, classes, methods, and other user-defined identifiers. The system has a source code editor comprising a code input module configured to accept a sequence of characters being input by a user and a location determination module configured to determine a current input location within the source code where the sequence of characters are being input. A lookup module in communication with the source code editor identifies constructs that are in the scope of the current input location, based on the current input location and the structure of the surrounding code, compares the identified constructs with the sequence of characters, and generates a list of scope-matched constructs that are available for use within the scope of the current input location and match the sequence of characters in whole or in part. In one embodiment, a regular expression using the sequence of characters is used in comparing with the identified constructs.

The system further comprises an output module configured to display the list of scope-matched constructs to the user in real-time as the sequence of characters are being input. An auto-completion module is configured to complete the inputted sequence of characters responsive to a selection of the scope-matched constructs listed. The scope-matched constructs identified may be limited to those that are contextually relevant to the current scope of the code being edited, such as those within the same function, class, or namespace. Code templates associated with a construct, e.g. based on type, class, function, or based on user-defined characteristics, may be located, adapted to the construct, and displayed for auto-completion.

A user interface element is configured to allow the user to select one of the listed constructs, statements, or code templates for insertion into the source code. The location determination module and lookup module are configured to update the list of scope-matched constructs in real-time as the user continues to input characters to the sequence of characters, dynamically refining the list based on the continued input.

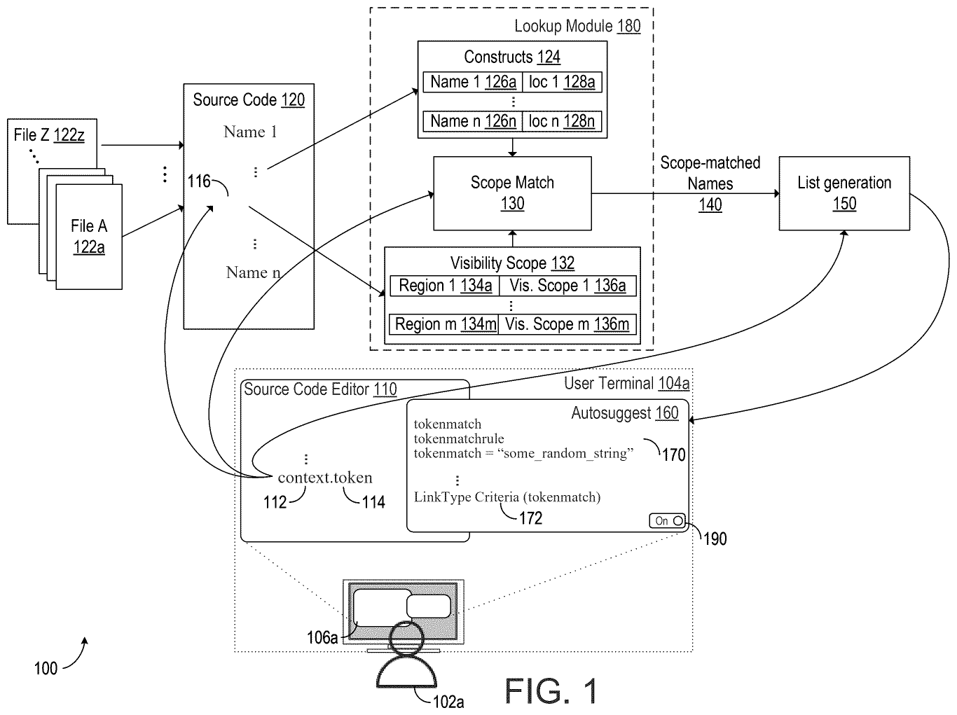

FIG. 1 is a distributed Integrated Development Environment (IDE) 100 including user terminal 104a operated by user 102a. IDE 100 also comprises other user terminals 104b-n and a project server 1190 (detailed further below) to facilitate cooperative development with other users 102b-n (details not shown). Each user terminal has a local IDE (106a-n) comprising a source code editor (110a-n). The user terminals 104 are interconnected allowing them to synchronize and share various attributes and pieces of source code between them. Each IDE 106 need not be identical. Various aspects will be illustrated below whereby users 102 edit source code within a shared project. A user terminal comprises a processor connected to memory. Various applications and modules can be stored in the memory for execution with the processor, in communication with the processor and between the modules and applications, including components of IDE 106a (detailed further below). Illustrated here is source code editor 110a in which user 102a is editing source code 120 via a user interface. IDE 106a comprises a compiler (not shown), which can be used to compile the source code. Functions to perform the various methods and functions detailed further below, such as parsing and analyzing the source code, may be carried out by processor 120 via a compiler function, although a compiler is not required.

Source code 120 comprises source code stored in one or more files A-Z 122a-z. Source code 120 may reside in user terminal 104a, on a server, shared with others in a distributed IDE, or any combination thereof. A plurality of construct names 126a-n from source code 120 are stored in constructs 124 of lookup module 180, which can be any type of data structure (e.g. a simple list or an Abstract Syntax Tree) that includes the construct names (or a subset thereof) of the constructs existing in source code 120. Constructs 124 also stores source code locations 128a-n associated with each construct name 126a-n.

A visibility scope data structure 132 in lookup module 180 stores a visibility scope 136 associated with each identified region 134 in the source code. Again, the data structure can be any type, e.g. a list or AST, which associates a region with a visibility scope. Here, m visibility scopes 136a-m are stored for m regions 134a-m. Each region is a portion of the source code containing a plurality of locations containing source code. A region can be delineated in any fashion, an example using ascii character-based source code is to identify boundaries of a region with line and character numbering. A visibility scope is comprised of one or more regions within source code 120. Any construct 124 having a location 128 within one of those regions is within the visibility scope 136 of the region 134.

User 102a is shown using a source code editor 110 in IDE 106a. The source code editor 110 has a code input module configured to accept a sequence of characters being input by the user. This sequence is represented as token 114. The source code editor 110 has a location determination module which identifies where in source code 120 token 114 will be inserted, the current input location 116 as shown. The location may be identified by line and column numbers in a file or may be maintained in a data structure such as an AST (detailed further below). Source code editor 110 further comprises a context determination module for identifying context of the sequence of characters being entered as token 114, identified as context 112. Context may be maintained in data structures such as an AST, symbol table, object table, and similar, and may include any number of contexts, including whether the location is within a function, object, argument, string, and others.

Scope match 130 of lookup module 180 generates a set of scope-matched names 140, where a scope-matched name is identified as a name 126 of a construct 124 string-matching, in whole or in part, token 114, and having a location 128 within the visibility scope 136 of the region 134 containing current input location 116. List generation 150 receives the scope-matched names 140 and the context 112 of token 114 to generate a list 170 comprising a set of list elements, each list element comprising one or more scope-matched names 140 or constructs comprising one or more scope-matched names 140 embedded within other source code determined to be relevant based on context 112. Context 112 may be used to determine aspects about a potential construct name match, such as a function, class or namespace. The list 170 is presented in autosuggest module 160. In this example, “tokenmatch” is used to signify a construct that scope-matches to token 114, and the first three illustrations include the construct tokenmatch, another called tokenmatchrule, and tokenmatch included in a surrounding expression. These aspects will be detailed further below.

List elements may be constructed from code templates (typically but not necessarily outside of source code 120). An example detailed below is for link-type objects. Various link-type criteria may be autosuggested in response to link-type objects or types string-matching to the token or in the context surrounding it. A code template may be optionally tailored to incorporate the construct string-matching the token. LinkType Criteria (tokenmatch) 172 is illustrated in list 170, where a code template is tailored with the illustrative scope-matched construct tokenmatch.

An output module, illustrated as autosuggest 160, presents the list 170 of list generation 150, providing the opportunity for a user to select or to keep typing. Token 114 grows with each additional character entered into the sequence of characters, until it is completed as indicated by a delimiter inherent in the source code language being used. As each character is entered, the scope-matched names 140 and list 170 is updated in response. A user can select from the list at any time, in which case that list element will be placed into source code 120 at location 116. The user can ignore the suggestions and keep entering characters. An option for the user to discard the list prior to completion of the token may be provided. In one embodiment the autosuggest 160 window disappears automatically when a delimiter defined in the source code indicates the token is complete (e.g. a space, dot, or various other characters), or when additional characters following such a delimiter are entered.

An IDE may comprise a variety of autocomplete options for user selection, such as keyboard navigation (e.g., arrow keys), type-ahead filtering to refine suggestions, and prioritizing context-relevant options based on the coding environment. Users may utilize shortcut keys for quick selection, such as tab or enter keys. Users may customize IDE autocomplete settings to suit their preferences.

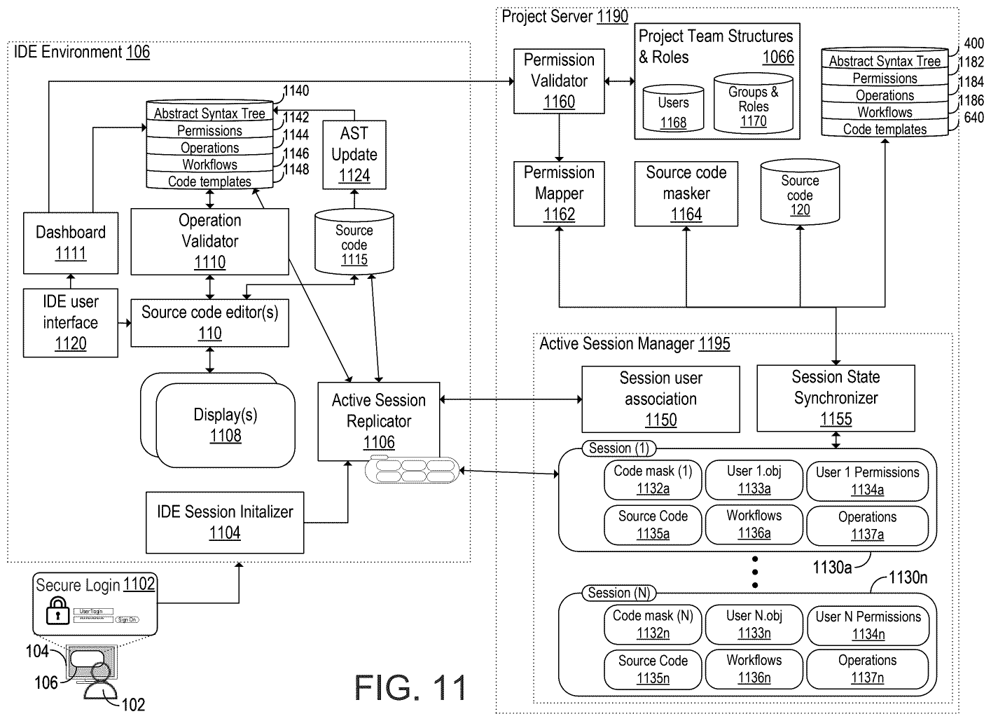

A switch 190 is included to turn on or off the use of code templates in list generation. In this illustration, link-type criteria are selected or deselected for inclusion in the construct list 172. In general, any number of types of code templates could be candidates for list generation, and those types can be enabled or disabled in a control dashboard in an alternate embodiment detailed below in FIG. 11.

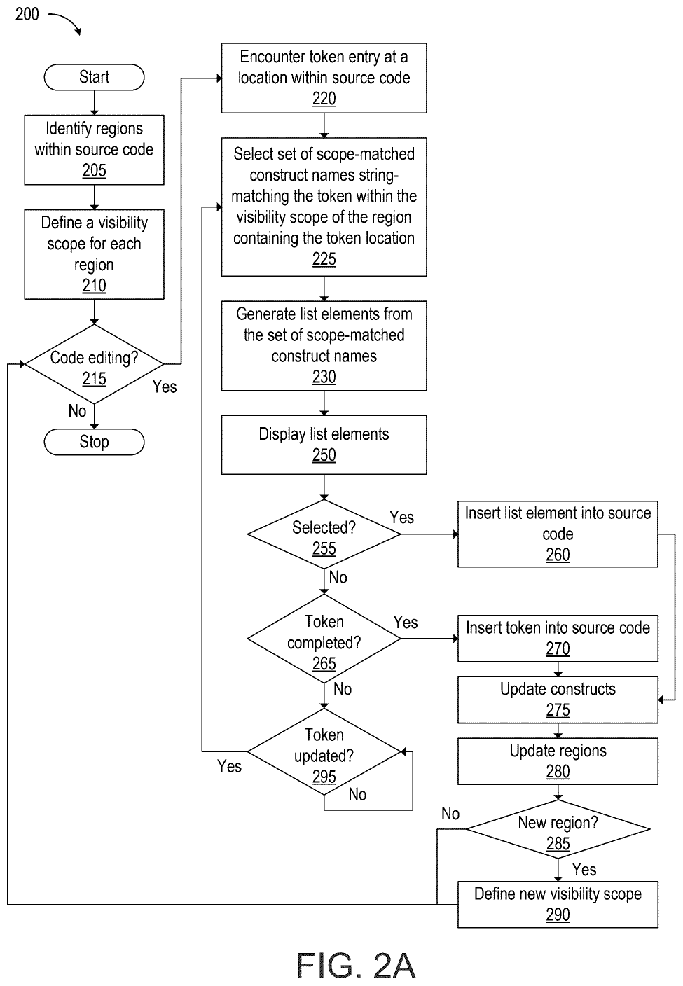

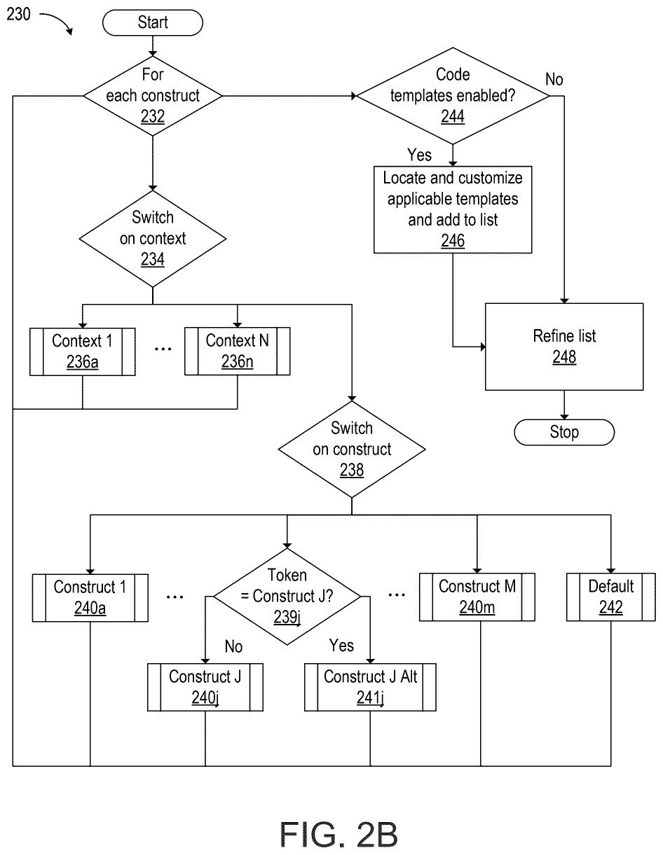

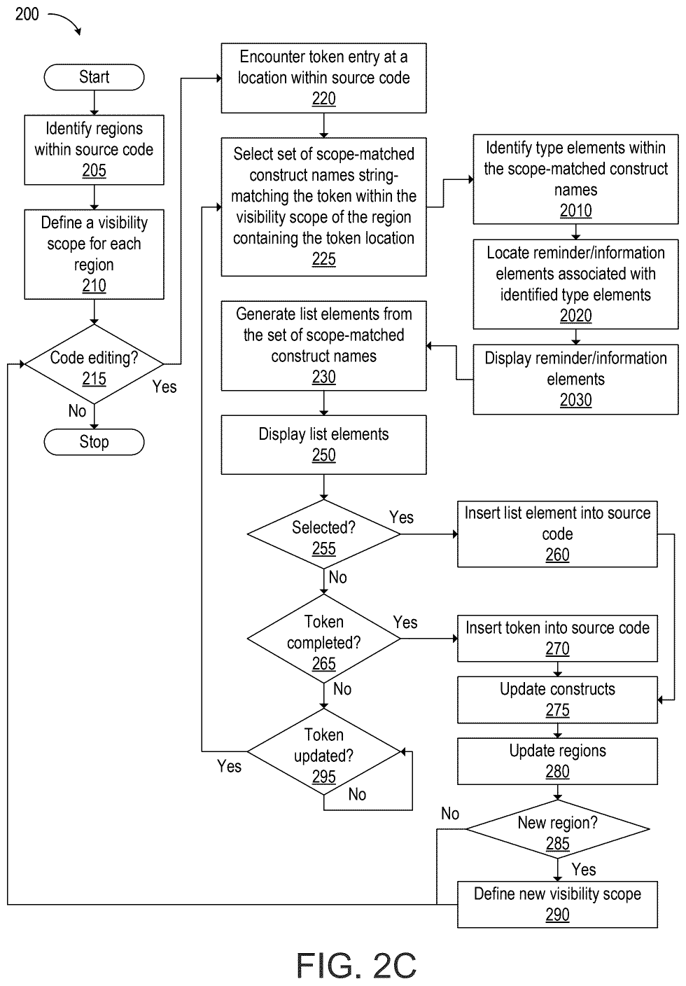

FIG. 2A is a flowchart 200 illustrating a method of scope-based autosuggestion. Operating on source code located in memory and/or loaded from one or more files, identify regions within the source code (205). In the embodiments detailed herein, the method 200 can be designed such that regions can be selected using any methodology. For each region, define a visibility scope (210). A variety of alternate embodiments may be deployed to determine visibility scopes, and to save, store, and process regions and visibility scopes. Several examples are detailed further below.

If the source code is being edited (215) then encounter a token entry at source code location (220). With the token, initially consisting of the first of potentially a sequence of characters, select a set of scope-matched construct names string-matching the token within the visibility scope of the region in which the token location is contained (225). List elements are generated from the set of scope-matched construct names (230) and displayed (250) for optional selection by the user. If a list element is not selected (255), then a check is made as to whether the token is completed (265). If not the process loops until the token is updated (295). Once a new character is received, it is added to the token, and the process returns to 225 to update the set of scope-matched construct names based on the updated token. The list elements are regenerated as necessary (230) based on any modifications to the set of scope-matched construct names, and the list displayed is updated accordingly (250) and remains available for selection (255). While this example embodiment uses a loop monitoring and responding to keystroke entry as an illustration, in practice it is common to have keystroke entry processed with an interrupt handler and a keystroke buffer. As such, the loop may be interrupted in process, and upon execution control returning, the loop can be restarted at 225 with an updated token, without the need to complete a loop in progress on the earlier token version. The token may be updated with any number of characters from the keystroke buffer.

FIG. 2B illustrates an example list generation process 230. A variety of subprocesses may be defined for processing each scope-matched construct to determine whether it should be included, as well as whether additional constructs related to the scope-matched construct should accompany it in the list. The subprocesses may be selectively applied to each construct based on the construct itself, as well as its context. Process (230) loops through each construct in the set of scope-matched constructs. Here a set of N contexts are defined, along with a set of N context subprocesses, Context 1-N (236a-n). A switch 234 determines if the context of the construct under evaluation matches any of the defined contexts for which a subprocess 236 is defined. If so, the corresponding subprocess is performed.

If the context does not match any of the N defined contexts, then the construct itself is evaluated. A set of M constructs are defined, along with a set of M context subprocesses, Construct 1-M (240a-m). A switch 238 determines if the construct matches any of the defined constructs for which a subprocess 240 is defined. If so, the corresponding subprocess is performed. Optionally, additional tests may be included to delineate alternate subprocesses. For example, additional or alternate steps in Construct J Alt process (241j) are carried out when the construct is equal to the token (239j), not just a string match, and Construct J subprocess 240j is executed otherwise. If no matching context or construct is found, a default subprocess 242 may be performed. One option is to include the construct in the list as a default step.

Each subprocess 236, 240, 241, or 242 will result in the construct being ignored, or added to the list, potentially as part of a larger statement. After a subprocess is run, the next construct is selected and processed (232) until all the scope-matched construct names have been processed. If code templates are enabled for list generation (244), then locate and customize applicable templates and add them to the list (246).

In either case, the list may be refined (248). A variety of refinements may be included. One example is to remove duplicate entries. Another is to limit the list of otherwise includable elements, particularly if the number of list items would be unwieldy to present to the user. A prioritization of certain completions or constructs over others may be defined. List generation may be paused until the token size is large enough to prevent no more than a desired number of constructs from string matching. List generation module 150 can provide any ordering of elements in the list. For example, the elements may be provided in scope order: from local to outer to global scope, or vice versa.

Returning to FIG. 2A, when a list element is selected (255), it is inserted into the source code at the token entry location (260). If a list element is not selected, and the token is completed (265), then the token is inserted into the source code at the token entry location (270). The list of constructs (e.g. constructs 124) is updated in accordance with the construct or constructs introduced (275).

Any regions affected by the insertion of new code, a list element or a token, are updated (280). If the new code comprises a construct that would necessitate a new region in accordance with the region definition methodology, the new region is defined (285). Then a new visibility scope for the new region is defined (290). In either case, the process returns and continues to process the next token, so long as editing is ongoing (215). When editing is complete, the process stops.

Alternate embodiments may incorporate generating more than one list, for alternate purposes, using the techniques detailed in FIGS. 2A and 2B. In one embodiment, a list of one or more elements may be generated to provide information or a reminder prompt to the developer. This list is kept separately from auto-suggestion list (230) and is displayed in a format to distinguish it from the display of the auto-suggestion list (250). Any set of criteria may be deployed to select reminder list elements responsive to selecting the set of scope-matched constructs string-matching the token being entered into the source code editor (225). In one embodiment, type elements are identified within the scope-matched constructs, if any, and information or reminder elements associated with a type element, if applicable, are displayed to the user.

FIG. 2C is flowchart 200 illustrating a method of scope-based autosuggestion modified to further provide scope-based information or reminder elements. In this embodiment, after the set of scope-matched construct names string-matching the token are selected (225), the process identifies type elements within those construct names (2010). If there is any reminder or information elements associated with any of the identified type elements they are located (2020). The located reminder or information elements, if any, are then displayed (2030). In the example embodiment, detailed further below, the reminder list of elements displayed include any computed entities or behavioral properties which include an identified type element. The process then returns to generate the auto-suggestion list (250) as described above.

In this example, both types of lists are displayed to the user. An alternate embodiment may deploy a reminder list only, in which the methods of 230, 250, 255, and 260 are omitted. Furthermore, the set of scope-matched constructs may be limited to a subset based on a particular embodiment. In the reminder-list-only example just described, information list elements are limited to those associated with elements of a type. Therefore, the set of scope-matched construct names needs only to include type elements that are found within the scope. Alternate subsets of constructs may be selected in various embodiments. In this example, the type elements are identified from the scope-matched elements, which may appear when the token is just a portion of the matching type elements. An alternate may require the token to match the type element to be included in a reminder prompt list. This is an adaptation to taking one course of action, include, when the token equals a construct (241j), or another course of action, exclude, when the token is not equal (240j).

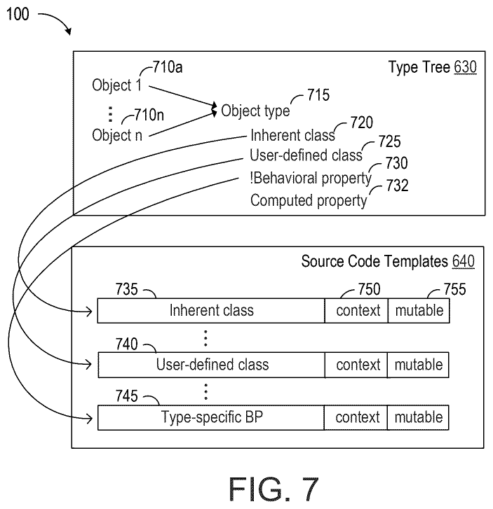

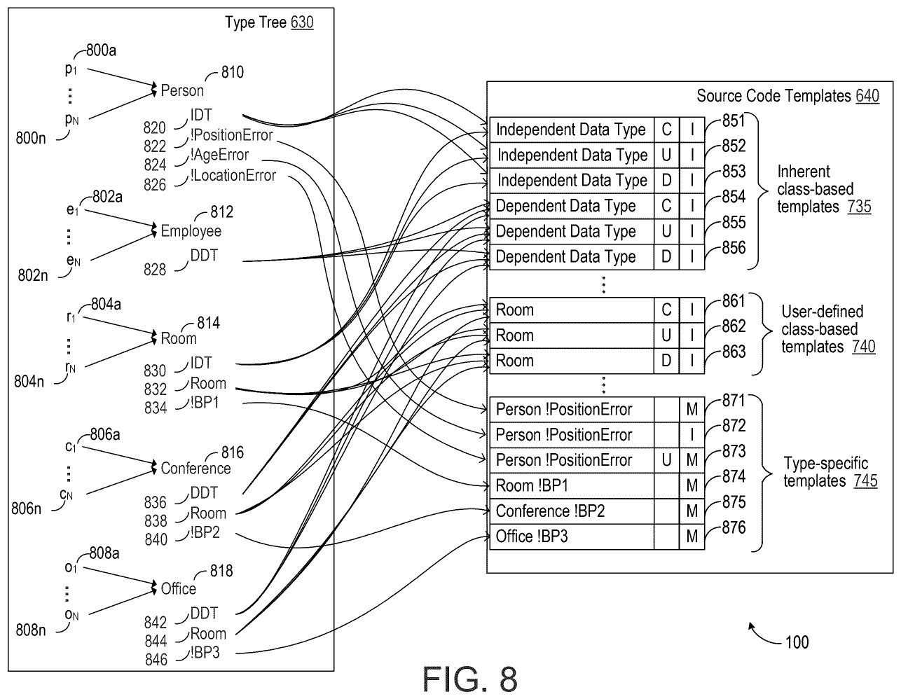

In an embodiment, scope matching is not deployed. One or more type definitions are encountered in source code, each having at least one type element. One or more type definitions may have one or more properties defined. Some properties may be associated with one or more type elements. The relationship between type definitions, variables of the type, elements of the type, properties, and their relationship to one or more elements, and the like, may be stored in a data structure that tracks a syntax structure and semantic model of the source code. Examples are illustrated with respect to FIGS. 7 and 8 below. When a token is entered into the source code editor that matches or string-matches a type element, if there is a property defined in the type element's type that is associated with the type element, that property is displayed. Association includes the type element within an expression defining the property, or the name of the property itself. Example properties include behavioral properties and computed properties (e.g. computed entities).

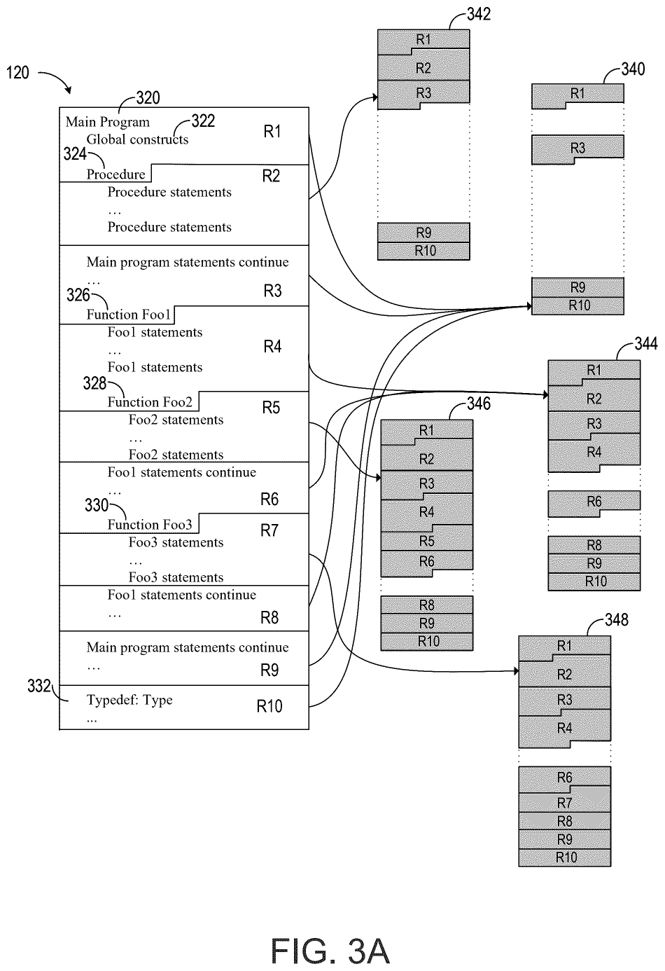

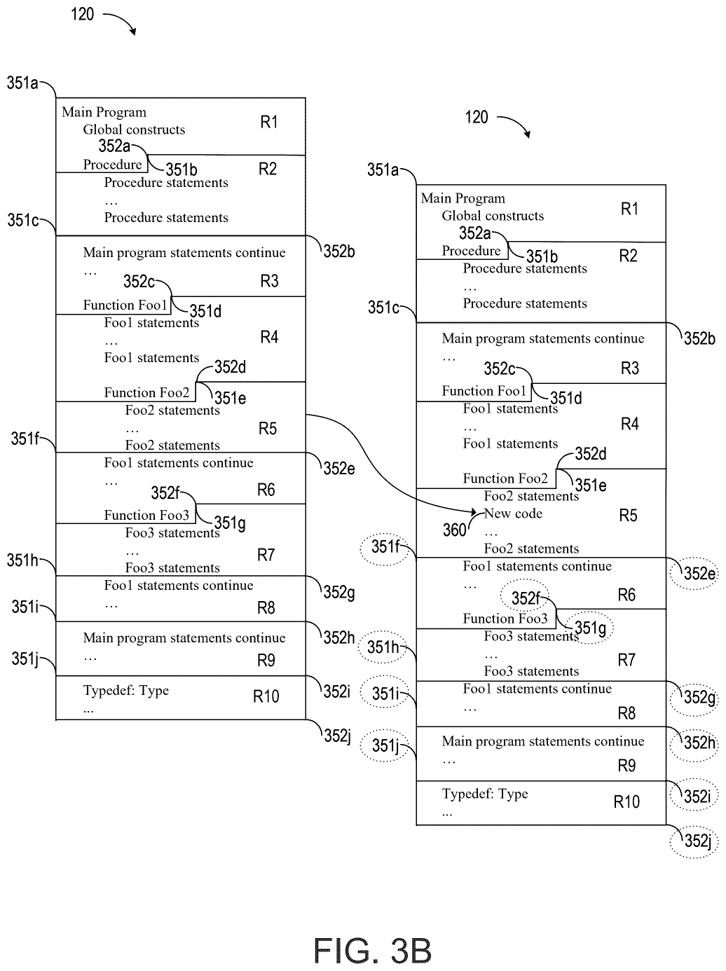

FIG. 3A illustrates source code 120 being divided into regions with defined visibility scopes using scope in accordance with semantic and syntactic requirements of the programming language. FIG. 3B illustrates region boundaries delineating the regions R1-R10 and illustrates updating the source code and region boundaries in response to the insertion of new code.

Different programming languages may be defined with different scoping rules. When compiling, symbol tables are often structured to have multiple levels corresponding to different scopes in the source code. Each scope can have its own symbol table, or more commonly, entries in a central symbol table that include scope information. When a new scope is entered, such as when entering a function or a block, a new level is added to the symbol table. This allows the same identifier to be used in different scopes without conflict.

Symbol tables can be implemented using a stack-like structure where entering a new scope pushes a new symbol table onto the stack, and leaving a scope pops the symbol table off. This mechanism ensures that variable names declared in a block are only visible within that block and do not interfere with names in other scopes. In this structure, when looking up a variable, the search starts from the top of the stack (the most immediate scope) and moves downwards towards the global scope. This prioritizes local declarations over outer declarations. In languages supporting nested functions or closures, the concept of a scope chain is used, where each environment has a reference to its parent environment. This chain allows the compiler or runtime to resolve identifiers by walking up the chain until the identifier is found or the global scope is reached. Each entry in a symbol table typically includes not just the identifier name, but also additional information such as its type, scope level, memory address (if already allocated), and possibly a link to its declaration node in the AST. Similar techniques for determining scope, and hence visibility scope, may be deployed in various embodiments.

In the following examples, the scope location is specified based on the position in the abstract syntax tree of the program. It is classified into three parts: the inner scope, the outer scope, and the global scope. The position of the scope defines the visibility and accessibility property of the corresponding scope. Scope components are the set of objects, fields, or constructs that present within the scope. The visibility and accessibility properties specify the access between objects. Intra-scope object access have full control over the other objects that are within the same scope and all fields/objects/constructs are visible to each other. From the inner scope, objects present in the outer scope are visible and hence accessible. From the outer scope objects, inner scope objects are not visible and hence not accessible. The global scope is visible and hence accessible from other scopes

In FIG. 3A, the source code, an example pseudocode, is segmented into 10 regions R1-R10. Main program 320 comprises global constructs 322, Procedure 324, function Foo1 326, and type definition Typedef 332, among various other main program statements. Foo1 326 comprises function Foo2 326 and Foo3 330, among various other Foo1 statements.

Main program 320 has a scope, which includes its own statements and variables, as well as the construct names for procedures, functions, and type definitions within its scope, along with their arguments and properties. The main program scope does not include the inner scope of those procedures, functions, and type definitions. As such, regions are determined accordingly. In one embodiment, the following is an example set of scoping rules. The main scope can access inside the type: i) public members (fields, methods, properties) of the type, ii) internal/protected members in some cases, and iii) Static members (if applicable). Private or protected members of the type are usually not accessible from the main scope. Inner scope inside the type definition, e.g. within its methods, nested types, etc., typically access is available for: i) all members of the type (public, private, protected, and internal), ii) static and instance members (depending on whether the inner scope is static or instance), iii) nested types and their members, and iv) sibling types and their non-private members.

Turning to FIG. 3B, region R1 begins with the first location in source code 120 (351a) and ends at the beginning of the inner scope for Procedure 324 (351b), where R2 begins (351b). R2 ends following the end of the procedure statements (352b), where the main program statements continue and R3 begins (351c). Similarly, the scope of main program 300 does not include the inner scope of function Foo1 326, so R3 terminates (352c) at the beginning of the inner scope of Foo1 326. The main program statements continue once more following the end of the Foo1 statements, which marks the beginning of R9 (351i). The scope of Typedef 332 is included in the scope as well, which begins (351j) at the end of region R9 (352i) and terminates at the end of source code 120 (352j).

Returning to FIG. 3A, the main program scope is thus made up of 4 regions, R1, R3, R9, and R10, which define a visibility scope 340. Each of these regions have visibility scope 340 associated with them.

Procedure includes in its scope its own inner scope, R2 302, as well as its outer scope, which is that of main program 300. Thus, visibility scope 342 is defined which includes all of visibility scope 340 as well as R2 302, as shown. Visibility scope 342 is associated with R2.

In similar fashion, the scope for Foo1 will include its inner scope and outer scope as well. Its inner scope includes the constructs Foo2 328 and Foo3 330, but the inner scope of each of those functions is excluded. Therefore, this section of code is divided into additional regions. The inner scope of Foo1 comprises various Foo1 statements residing in the regions R4 (having boundaries 351d and 352d), R6 (having boundaries 351f and 352f), and R8 (having boundaries 351h and 352h). The visibility scope 344 for Foo1 includes its inner and outer scope and is comprised of all regions except those carved out for Foo2 and Foo 3, as shown. Each region within the scope of Foo1 (R4, R6, and R8) is associated with visibility scope 344.

The inner scope of Foo2 is made up of the various Foo2 statements in region R5 (having boundaries 351e and 352e). Its associated visibility scope 344 comprises all regions except R7 (the inner scope of Foo3), as shown.

The inner scope of Foo3 is made up of the various Foo3 statements in region R7 (having boundaries 351g and 352g). Its associated visibility scope 346 comprises all regions except R5 (the inner scope of Foo2), as shown.

FIG. 3B shows source code 120 prior to and after the insertion of new code 360, which is entered into a location in region R5 305. Subsequent to the entry of the new code, as shown, some of the region boundaries will be updated, specifically boundaries 351f-j and 352e-j (those circled). The entry of new code could be a completed token or a selection of autosuggested code. If the new code contains a construct requiring it, such as a function or procedure definition, a new region will be created as well, and visibility scopes updated as required.

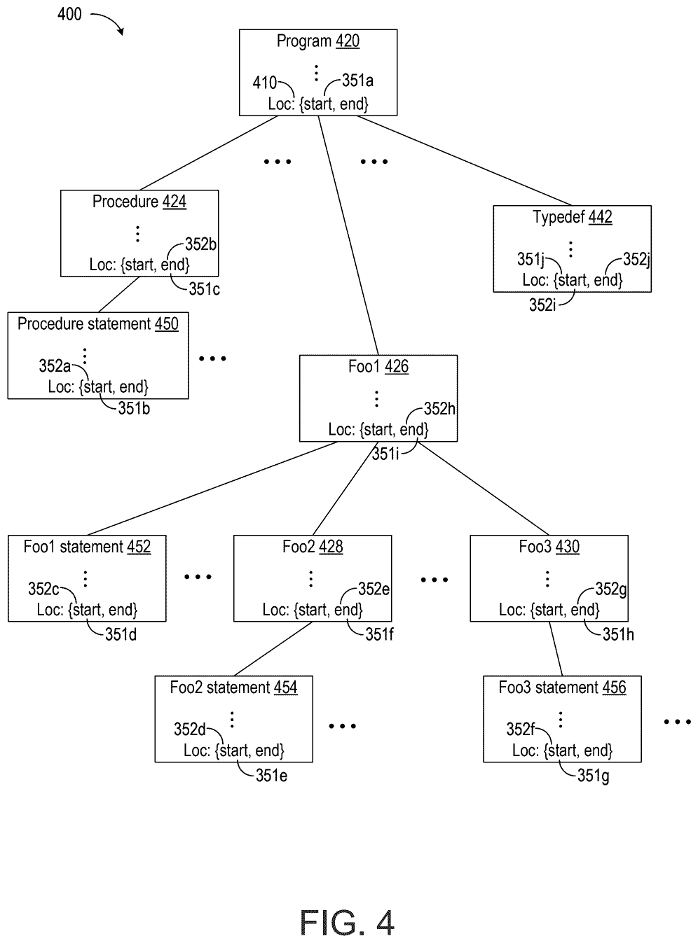

FIG. 4 illustrates a conceptualized Abstract Syntax Tree (AST) 400 including region boundaries. An AST is a convenient data structure for maintaining, among various other aspects, scope. The generalized process is as follows.

The source code is first parsed by the compiler or IDE's parsing engine, converting the linear sequence of tokens (lexical components of the programming language like keywords, operators, identifiers, etc.) into a structured AST. The AST represents the syntactic structure of the code in a tree-like format, where each node represents a construct such as a statement, expression, or declaration. Each node in the AST corresponds to a language construct and includes information about its type (e.g., a function definition, a variable declaration) and its relationship to other nodes (e.g., a node for a function might contain child nodes for each of its parameters and statements).

In most programming languages, scopes are defined by specific syntactic constructs. For example, in C-like languages, { } brackets typically delineate the beginning and end of a scope. Functions, classes, and conditional blocks each create their own scopes. In the AST, scopes are generally represented by nodes that can contain other nodes. For example, a function node will contain nodes for its parameters and body, which may contain further nodes for statements and declarations within the function. To determine what symbols (e.g., variables, functions) are accessible in which parts of the code, the compiler or IDE traverses the AST and maintains a symbol table. As it enters a new node that represents a scope, it typically: (a) adds a new layer to the symbol table for that scope; (b) records declarations within that scope into this new layer; and (c) resolves references to symbols within expressions and statements by checking the current and all outer scopes until the symbol is found or until all scopes are checked. When the traversal leaves a scope (i.e., moves back up the AST from a node that introduced a new scope), the corresponding layer in the symbol table is removed or marked as inactive. This ensures that symbols declared within a scope are not accessible outside of it, adhering to the language's scoping rules.

As the AST is traversed, the compiler or IDE also performs checks for errors such as variables used before declaration, type mismatches, or unauthorized accesses to restricted scopes. These checks are crucial for early detection of common coding errors and are made possible by the detailed scoping information maintained during the AST traversal.

In an example IDE, this process allows features like syntax highlighting, code completion, and intelligent refactoring. In the example embodiment, when a user types a construct name, the IDE uses the AST and its associated scope information to offer completion suggestions based on the variables currently in scope, based on the location in which the user is entering the token.

Each node in the AST 400 has a construct name, details about the construct including arguments (not shown), and a source code location 410 having a start and an end. Statements within the scope of the node are included as branches of the node. The example boundaries described in FIG. 3 can be mapped onto AST 400.

Main program 320 is represented by Program node 420. Region boundary 351a for region R1 is the start location of Program node 420. Program node 420 comprises branches to Procedure node 424, Foo1 node 426, and Typedef 442, along with various other statements prior to and between these example branches (not shown).

Procedure node 424 comprises a first Procedure statement node 450 among other statement branches (not shown). The construct name Procedure (and main program statements and global constructs prior to it) is within R1 301, but its statements are not. Therefore, the start location for the first procedure statement 450 marks the end boundary 352a of region R1 as well as the start boundary 351b of region R2. Region R2 ends after Procedure and main program statements continue in R3, so the end location of Procedure marks the end boundary 352b of R2 and the start boundary 351c of R3.

Foo1 node 426 comprises a first Foo1 statement node 452, function Foo2 node 428, function Foo3 node 430, and various statements in between them (not shown). As before, the construct name Foo1 resides within region R3, but its statements and nested functions do not. So, the start location of the first Foo1 statement marks the end boundary 352c of R3 and the start boundary 351d of R4. The end of the scope of Foo1 is end boundary 352h of R8, which is the end location of Foo1 426. The Foo1 code is divided into various regions: R5 for Foo2, R7 for Foo3, and R4, R6, and R8 for the other Foo1 statements. Each of function nodes Foo2 428 and Foo3 430 have first statement nodes 454 and 456, respectively, among other statements (details not shown). The Foo1 regions are delimited with the start location of first Foo2 statement node 454 marking end boundary 352d of R4 and start boundary 351e of R5, the end location of Foo2 statement node 428 marking boundary 352c of R5 and start boundary 351f of R6, the start location of first Foo3 statement node 456 marking the end boundary 352f of R6 and start boundary 351g of R7, and the end location of Foo3 statement node 430 marking end boundary 352g of R7 and start boundary 351h of R8.

The start boundary for R9 is marked by the end boundary 351i of Foo1 node 426. The start location of Typedef node 442 marks the end boundary 352i of R9 and the start boundary 351j of R10. The end location of Typedef node 442 marks the end boundary 352j of R10.

It can be seen that AST 400, which can be used for various other compilation and/or IDE processes, is a suitable data structure for use in defining regions in source code that can be combined to form visibility scopes. It is one example of generating a data structure that tracks a syntax structure and semantic model of a source code program comprising a plurality of constructs. A compiler (or subset of functions in an IDE that parse and analyze) can be deployed to monitor updates to source code from one or more users in a distributed IDE and update the data structure dynamically. The region-by-region example detailed above is illustrative. Generating and checking scopes within source code is typically intrinsic to the compiler or IDE, so if those scoping techniques match the general visibility scope techniques detailed herein, the built-in scope generation can be used.

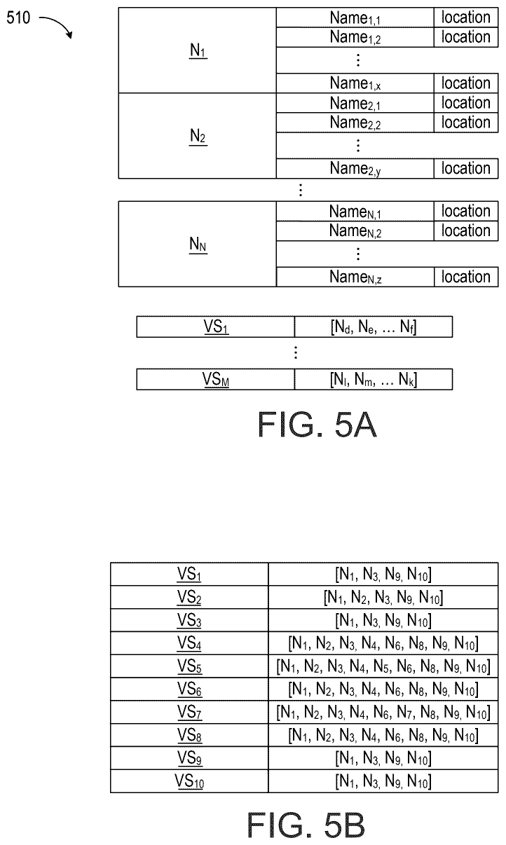

FIG. 5A is visibility scope data structure 510. It can be used as an alternative to or in conjunction with an AST 400. In this embodiment, there are N lists of construct names for N regions, N₁, N₂, . . . . N_{N}. Each list N comprises one or more construct names, each construct name linked with its location in source code. The length of each list N can vary, with the respective lengths of lists N₁, N₂, . . . . N_{N} being x, y, . . . z, such that the N lists are made of construct names Name_{1,1}, Name_{1,2}, . . . . Name_{1,x}, Name_{2,1}, Name_{2,2}, . . . . Name_{2,y}, . . . . Name_{N,1}, Name_{N,2}, Name_{N,z}, respectively.

Visibility scope data structure 510 also comprises M visibility scopes VS₁, . . . . VS_{M}. Each visibility scope is a list of one or more lists N. A visibility scope may be associated with one or more regions when those regions share the same scope (M<N) and a mapping from region to visibility scope can be employed. Or, a visibility scope can be defined for each region (M=N), even though some of those visibility scopes may be duplicates.

FIG. 5B illustrates visibility scope data structure 510 using the example source code 120 of FIGS. 3A-B. Here a visibility scope is saved for each region (even though some are duplicates), each of which is a list of name lists, which match the region visibility scopes of FIG. 3A. So VS₁, VS₃, VS₉, and VS₁₀=[N₁, N₃, N₉, N₁₀]. VS₂=[N₁, N₂, N₃, N₉, N₁₀]. VS₄, VS₆, and VS₈=[N₁, N₂, N₃, N₄, N₆, N₈, N₉, N₁₀]. VS₅=[N₁, N₂, N₃, N₄, N₅, N₆, N₈, N₉, N₁₀]. VS₇=[N₁, N₂, N₃, N₄, N₆, N₇, N₈, N₉, N₁₀].

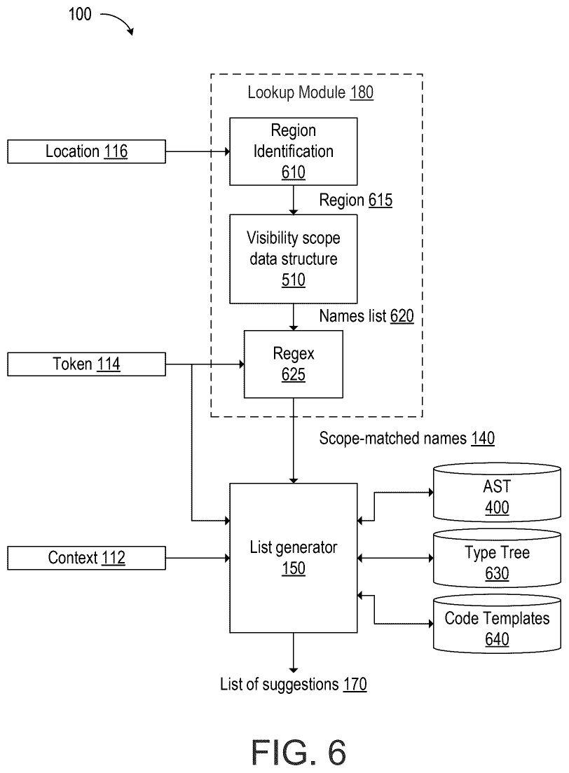

FIG. 6 is an embodiment of an IDE 100 using the visibility scope data structure 510 in lookup module 180, and illustrating the use of an AST 400, type tree 630, and code templates 640 with list generator 150. This is an example of a context access graph, a data structure which tracks the syntax structure and semantic model of the source code program, the data structure used in providing scope-matched autosuggestion. IDE 100 may also be deployed as a distributed IDE, incorporating a plurality of local IDEs, accommodating distributed updating of the source code by a plurality of users, an example of which is detailed below with respect to FIG. 11.

Lookup module 180 comprises region identification module 610, visibility scope data structure 510, and regex 625. Location 116 falls within a region 615 determined by region identification module 610. The identified region 615 is used to index visibility scope and data structure 510 to retrieve a names list 620, which, as described above, comprises all the construct names within the visibility scope. Token 114 is used in regex 625 to string match the names list 620 to produce scope-matched names 140. The list of scope-matched names 140 updates dynamically responsive to any additional characters entered into token 114.

List generator 150 receives the scope-matched names 140 and produces a list of suggestions 170 for presenting to the user to potentially select. The list 170 includes the scope-matched construct names, as updated dynamically, and can add additional list items based on the context 112 associated with token 114. For example, constructs or statements comprising one or more of the scope-matched names 140 can be generated based on the type or class of the token and the type or class of the name and include additional constructs surrounding the name accordingly. One or more code templates 640 may be added to list 170. A code template selected responsive to a class, type, or other property of the token context 112 may be tailored to one or more scope-matched names. List generator 150 may be connected to an AST 400, a type tree 630, and/or a code templates repository 640. Various other options may be deployed. Alternatively, for example, a symbol table with an entry for visibility scope may be used. Comparing the token with the names in the table, select scope-matched names from the regex-matched constructs having a corresponding visibility scope.

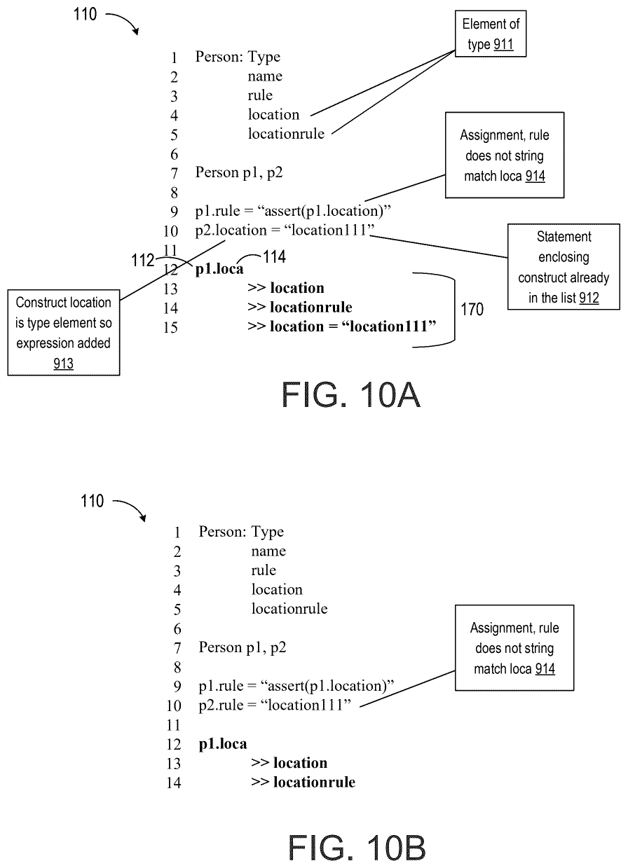

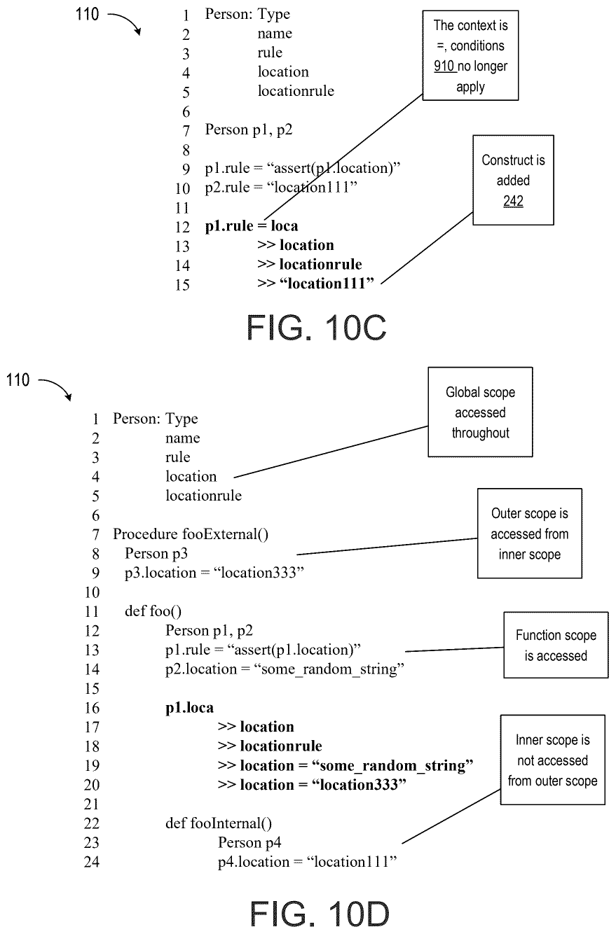

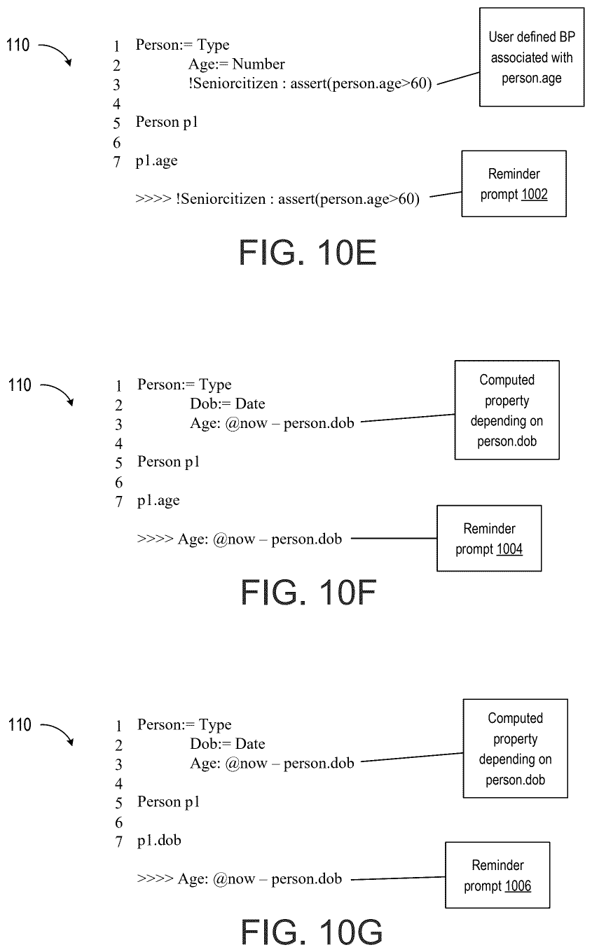

List generation module 150 can also use type tree 630 to evaluate the relationship between scope-matched constructs and related objects and types. In doing so, potential list items may be removed from consideration in suggestion list 170, or list items associated with related constructs may be added. A variety of illustrations are shown in FIGS. 10A-D. The embodiments of FIG. 7 and example of FIG. 8 illustrate how context can be utilized in determining list elements 170, and for proposing code templates tailored to a scope-matched name.

FIG. 7 details an exemplary embodiment of type tree 630 and source code templates 640 in an IDE 100. Type tree 630 comprises a collection of one or more object names, Object 1-Object n (710a-n), that are object names of an object type 715. Type tree 630 may have any number of object types included, with any number of object names for each object type. An object type 715 may have references to source code templates stored in source code templates 640, although it is not a requirement. Three types of source code templates are identified in the exemplary embodiment: those for objects in an inherent class based on inherent properties of the type of object 735, those for objects in a user-defined class 740, and those for user-defined templates that are type specific 745.

In the example embodiment, the programming language provides for link types. Link types are defined wherein an Independent Data Type (IDT) is referenced in defining a Dependent-link Data Type (DDT). Examples of link types and dependencies, referred to therein as role sharing types and dependencies, are detailed in U.S. patent application Ser. No. 18/335,035 to Sridhar Vembu et al., filed 14 Jun. 2023, and entitled “Role Extensions For Programming Languages,” which is incorporated herein by reference. Role sharing objects in the '035 application are referred to as linked objects herein. Linked objects may alternately be referred to as link or link-type objects. The types defined to instantiate linked objects are referred to as linked types.

Link types illustrate examples of inherent class. A link type can be an IDT, a DDT, or both. Due to the inherent relationship of linked objects, checks are performed at runtime prior to executing a link-type object management instruction on them. A variety of these checks may be defined for different types and constructs, which are referred to generally as link type criteria. When defined link type criteria are satisfied for a link-type object management instruction for an object at runtime, the instruction is carried out. For example, deletion of an IDT object may be prevented when there are DDT objects dependent on it. Instructions to check dependencies of an IDT object before deletion are applicable across the entire class of IDT types, and so a source code template 735 incorporating those instructions can be stored in source code templates 640.

Inherent class membership is determined according to the aspects of the programming language being used, and optionally in conjunction with a compiling function. In the example embodiment a type may be in the inherent class of IDT, DDT, or both. This is determined from a parse tree showing dependencies between link types. Each type may also be a member of one or more user-defined classes. A variety of techniques can be deployed to determine membership in a user-defined class. For example, a configuration file for a project may be maintained comprising user-defined classes and their type members. Class membership may or may not automatically include dependent types. If a type is determined to be a member of an inherent class for which source code templates are available, then a reference to each applicable code template is inserted in the type tree 630 for the type. Similarly, if a type is determined to be a member of a user-defined class for which code templates are available, then a reference to each applicable code template is inserted in the type tree 630 for the type.

Event handler autosuggestion in accordance with an AST 400 and alternate data structures with support for inherent and user defined type classifications, including IDTs and DDTs, is illustrated in copending U.S. provisional patent application Ser. No. 63/631,835, entitled “Integrated Development Environment Object Management Code Auto-Suggestion,” filed 9 Apr. 2024, by Sridhar Vembu et al., which is incorporated by reference herein (hereinafter the '835 application). Embodiments disclosed therein use structures for generating event handlers with source code templates, but those structures can be used for autosuggestion in general for source code templates alongside autosuggestion in other contexts. This is one example that can be incorporated with step 230 of FIG. 2A.

When an object 710 in type tree 630 is an object type 715 having an inherent class reference 720, DDT in this example, the reference 720 is used to locate the applicable inherent class source code template 735. Each source code template can be associated with a context 750. In the example embodiment, context may include whether the object management function is a create, update, or delete. For auto-suggestion, the context 750 can be used to select only the appropriate source code template, e.g. one which matches context 112 of token 114. In the '835 application, a mutability indicator 755 indicates whether the source code template should be identified as mutable or immutable in a draft event handler presented to a developer. Inherent source code templates for enforcing link type criteria for IDT and DDT objects are marked immutable. Source code templates can be designed generally for all inherent class types applicable to a particular computer programming language. They can also be modified or customized for a particular development team or project as well.

Developers may also identify one or more object types 715 to be part of a user-defined class. User-defined class source code templates 740 may be designed and associated with context 750 and mutability 755 indicators as well. A user-defined class reference 725 associated with an object type 715 is used to locate the appropriate user-defined class template 740 to be incorporated in the autosuggestion list 170

Source code templates 745 are specific to a particular type. In the example embodiment, one or more user-defined behavioral properties (BP), identified by the “!” character as a convention, may be defined in that type's definition. These behavioral properties return a response at runtime to an expression defined in the type definition operating on object elements. As defined earlier, a BP is used to ensure an object conforms to an expression constraint, is reevaluated automatically, and can return a variety of values such as a Boolean, error, string, or number. Alternate embodiments may employ other type-specific source code references and templates. A reference 730 associated with object type 715 in type tree 630 can be used to locate a type-specific BP source code template 745 to be incorporated in the draft event handler. Type-specific source code templates may be designed for use in a particular context and may be marked immutable as well.

The type tree 630 includes BP 730 and computed property 732 as elements of object type 715. A type tree is one example structure that can be used to store elements to be stored and retrieved for display in an information or reminder list, as described above with respect to FIG. 2C. In that example, a behavioral property or computed property is added to the list when a string-matched element of a type is being entered into the source code editor, and that element is included in the property. Examples are detailed further in FIGS. 10E-G below. A type tree embodiment (or other structure) may also keep a mapping from type entities to computed or behavioral properties in which they appear, e.g. to which they are associated, which is convenient for populating an information or reminder list. Various alternate data structures can be used to map object type elements to one or more associated properties, such as behavioral (e.g. constraint) or computed properties, for inclusion as information or reminder list elements.

The following code snippet introduces example type definitions used in illustrations below:

| 1 | Person := Type | # IDT |
|---|---|---|
| 2 | Name := String | |
| 3 | Aadhaar := Number(unique) | # ID Structural Property |
| 4 | Age := Number | |
| 5 | | |
| 6 | Employee := Person | # DDT |
| 7 | Designation := String | |
| 8 | | |
| 9 | Room := Type | #IDT |
| 10 | RoomNumber := Number(unique) | |
| 11 | NetworkID := Number | |
| 12 | Size := Number | |
| 13 | !BP1: assert(expression) | |
| 14 | | |
| 15 | Conference := Room | #DDT |
| 16 | Name := String | |
| 17 | Occupancy := Number | |
| 18 | !BP2: assert(expression) | |
| 19 | | |
| 20 | Office := Room | #DDT |

| | |
|---|---|
| 21 | Occupant := Employee |
| 22 | !BP3: assert(expression) |

Lines 1-4 define Person as a Type. This is an example of an Independent Data Type (IDT) defined with the built-in construct Type. Person has property Name, which is a string, property Aadhaar, which is a number and is defined as a unique property. An Aadhaar is an identification number for people in India. A social security number (SSN) is a similar identifier in the United States. A Person also has numerical property, Age, in this example. In the source code, “:=” denotes a type or element declaration and “:” denotes element or object usage. The use of pascal case (PascalCase) for object and element identifiers indicates a declaration and the use of snake case (snake_case) represents object and element usage. The delimiter “#” identifies comments.

Lines 6-7 define Employee as type Person. Employee is an example of a Dependent-link Data Type (DDT) as it is derived from IDT Person. Employee and Person are link types, as a person object can be instantiated, and an employee object can be linked to that person object. In this example, an employee has property Designation, a string which identifies an attribute for the employee.

The creation or existence of a DDT type instance is dependent on the creation or existence of the corresponding IDT type instance, and the DDT instance or object is linked to the IDT object or instance automatically.

Lines 9-11 define another IDT type labeled Room. An object of type Room has three variable elements and a user-defined Behavioral Property (BP). The variables include a unique number, RoomNumber, a network identifier number, NetworkID, and a number Size. A generalized BP is shown in line 13, called BP1 and identified as a behavioral property by convention with the “!” character. Here the behavioral property asserts a value based on the evaluation of an expression, named expression. In the example embodiment, BPs return a Boolean value in response to the expression defined with them. Other behavioral properties are also supported.

Two DDTs of type Room are defined, Conference in lines 15-18 and Office in lines 20-22. A conference room has a string element for its name and a number element indicating the occupancy limit of the room. An office has an Occupant element of type Employee. Each has a generic BP, BP2 and BP3, for illustrative purposes.

FIG. 8 is an example IDE 100 comprising a type tree 630 and source code templates 640 as applied to the example code snippet above. There are type entries made for the five types: Person 810, Employee 812, Room 814, Conference 816, and Office 818. When a variable of a type is declared in source code it is associated with the type in type tree 630. Thus, in this example, there are N variables of type Person p₁-p_{N} (800a-n) associated with the Person entry 810. There are N variables of type Employee e₁-e_{N} (802a-n) associated with the Employee entry 812. There are N variables of type Room r₁-r_{N} (804a-n) associated with the Room entry 814. There are N variables of type Conference c₁-c_{N} (806a-n) associated with the Conference entry 816. There are N variables of type Office o₁-o_{N} (808a-n) associated with the Office entry 818. A type tree 630 can use any data storage technique, including text-based variable names of declared type variables associated with text-based type names. In the example embodiment, as source code is processed in the IDE, tokens are parsed into a parse tree, including entries for defined types (810-818) as well as declared variables of those types. When a variable is declared for a type, it is associated with its defined type. This parse tree association is used to locate types and any associated references to templates in type tree 630. In the example embodiment, the IDE will support link type object definitions and will be able to determine from parsing the source code to which inherent classes a type belongs (IDT, DDT, or both).

Source code templates 640 (as detailed in FIG. 7) comprise inherent class-based templates 735, user-defined class-based templates 740, and type-specific templates 745. In this example, there are two inherent classes for data types: independent data types (IDT) and dependent data types (DDT). For each inherent class, there are templates defined for each of three object management functions: create, update, and delete. Thus, inherent class-based templates 735 comprise six source code templates: IDT templates for use in the create context 851, the update context 852, and the delete context 853, as well as DDT templates for use in the create context 855, the update context 856, and the delete context 857. In this example, all of the inherent class-based templates are marked immutable.

IDE 100 will determine types Person and Room are IDTs and types Employee, Conference, and Office are DDTs. Adding references to inherent templates results in Person 810 having IDT reference 820 and Room 814 having IDT reference 830 used to access the IDT templates 851-853. Similarly, Employee 812 has DDT reference 828, Conference 816 has DDT reference 836, and Office 818 has DDT reference 842, each reference to access DDT templates 854-856.

User-defined class-based templates 740 are defined for a class labeled Room, which is coincidentally the same name as the IDT Room type and the type of its dependent DDTs. Any grouping of types is supported. A template has been defined for each context of creating (861), updating (862), or deleting (863) an object of the types in the Room class. For illustration, these templates are marked immutable, but each template could be immutable or mutable as desired. Any technique for defining the user-defined classes may be deployed. The IDE uses this information when determining the classes in which a type may be a member and supplying references to user-defined group templates. In this example, Room 814 has Room reference 832, Conference 816 has Room reference 838, and Office 818 has Room reference 844, each reference to access Room templates 861-863.

Type-specific templates 745 comprise user-defined behavioral properties for specific types. Type Room 814 has !BP1 reference 834 which is used to access Room !BP1 template 874. In this example, since the context field does not contain an indicator for create, update, or delete, the source code template will be accessed for any of the object management functions applied to that type. Similarly, type Conference 816 has !BP2 reference 840 which is used to access Conference !BP2 template 875, and type Office 818 has !BP3 reference 846 which is used to access Office !BP3 template 876.

While it is possible to have a single IDE with a type tree 630 and source code templates 640 in an IDE 100, in the example embodiment, any number of developers can collaborate within the distributed IDE and synchronize and share source code as well as project definitions and parameters. New type definitions or updates to existing type definitions are synchronized to type tree 630, whether from one or more centralized repositories or utilizing peer-to-peer synchronization, both well known in the art, details omitted.

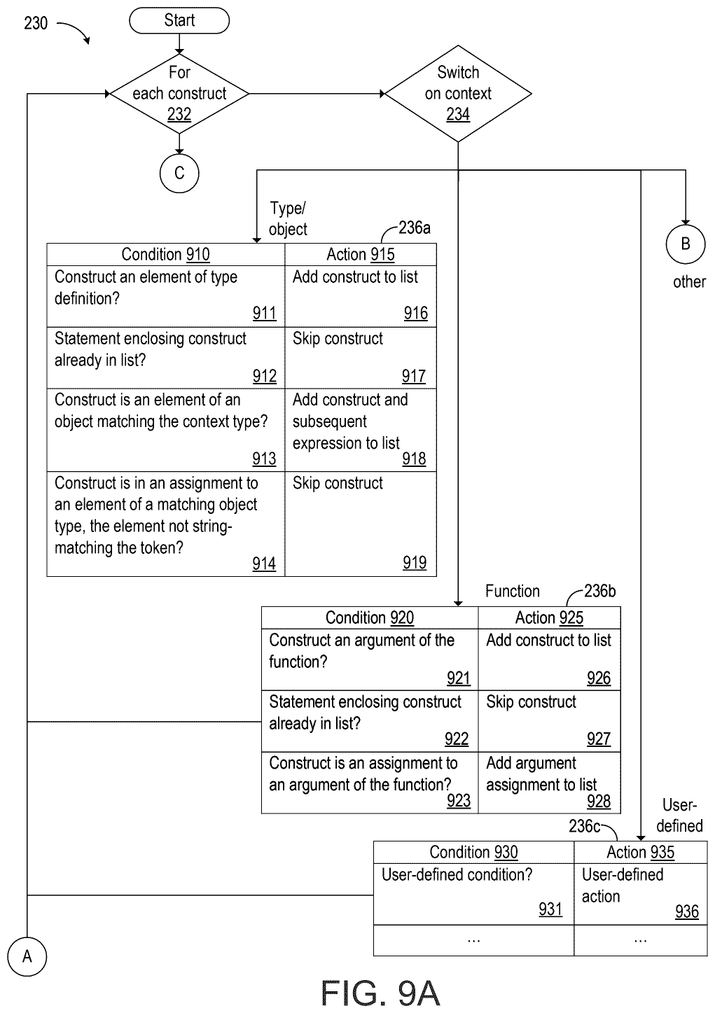

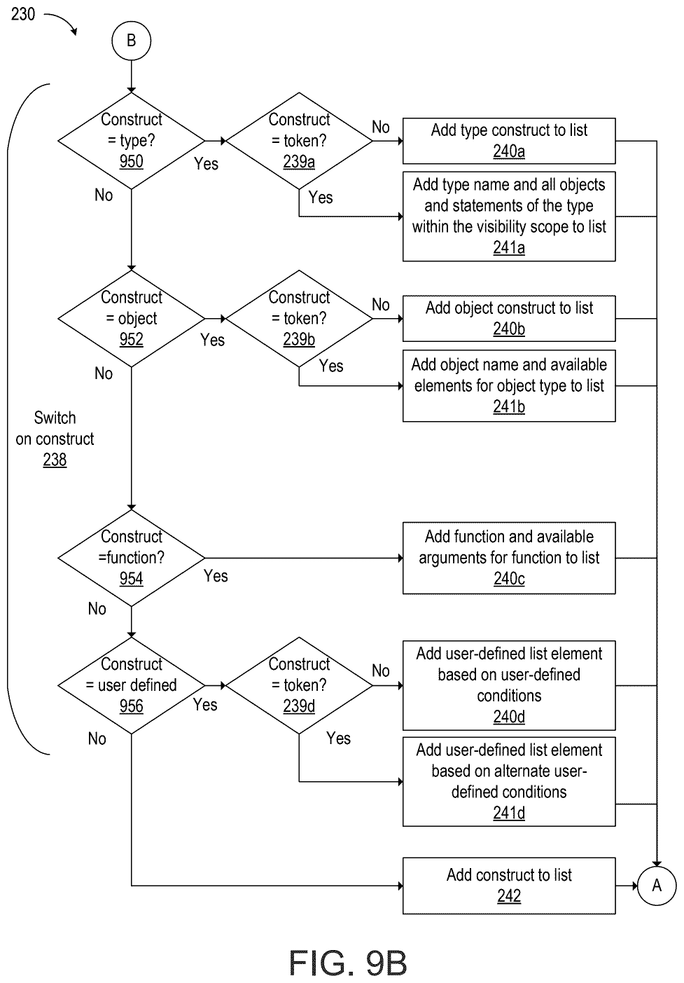

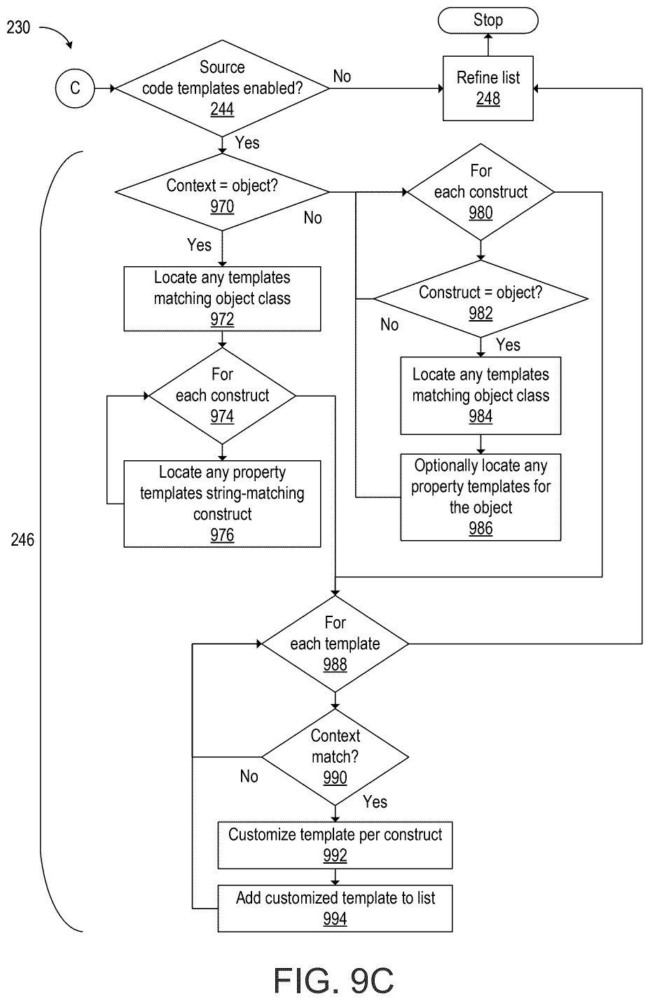

FIGS. 9A-C illustrate an example process 230 for list generation 150. It follows the format illustrated in FIG. 2B, with example contexts, constructs, and subprocesses. In FIG. 9A, process (230) loops through each construct in the set of scope-matched constructs. Here three contexts are defined, along with context subprocesses 236a-c. A switch 234 determines if the context of the construct under evaluation matches any of the defined contexts, which include type/object, function, and user defined.

If the context is a type or object, subprocess 236a is executed, which comprises conditions 910 and associated actions 915. If the construct is an element of a type definition (911) then the construct is added to the list (916). If the statement enclosing the construct is already in the list (912) then skip the construct (917). If the construct is an element of an object within the visibility scope of the token matching the context type (913) then add the construct and the subsequent element expression to the list (918). If the construct is within an assignment to an element of a matching object type (within the visibility scope), the element not string-matching the token (914), then skip the construct (919).

If the context is a function, subprocess 236b is executed, which comprises conditions 920 and associated actions 925. If the construct is an argument of the function (921) then the construct is added to the list (926). If the statement enclosing the construct is already in the list (922) then skip the construct (927). If the construct is within an assignment to an argument of the function (within the visibility scope) (923), then add the argument assignment to the list (928).

If the context is a user-defined context, subprocess 236c is executed, which comprises conditions 930 and associated actions 935. If the construct meets user-defined condition 931 then execute user-defined action 936. If the context does not match any of the defined contexts, then the other branch is executed, continuing in FIG. 9B.

Here the switch on construct 238 is enabled with a series of construct tests for any defined constructs. If the construct is a type (950), then, if the construct is not equal to the token (239a), add the type name to the list (240a). Otherwise, add the construct and all objects and statements of the type within the visibility scope to the list (241a). If the construct is not a type (950) proceed to the next test.

If the construct is an object (952), then, if the construct is not equal to the token (239b), add the object name to the list (240b). Otherwise, add the object name and available elements for the object to the list (241b). If the construct is not an object (952) proceed to the next test.

If the construct is a function (954) then add the function and available arguments for the function to the list (240c). If not, proceed to the next test.

If the construct is user-defined construct (956), then, if the construct is not equal to the token (239d), add a user-defined list element to the list based on user-defined conditions (240d), otherwise add a user-defined list element to the list based on alternate user-defined conditions (241d).

If the construct did not match any of the constructs in the series of tests, a default process is initiated (242). Here that action is to add the construct to the list. After any of the branches shown complete, the process returns (FIG. 9A) to process the next construct (232). Once all the scope-matched constructs are processed, proceed to the next step as shown in FIG. 9C.

If source code templates are enabled (244), then an example process 246 is shown. If the context is an object (970), then locate any templates matching the object class (972). Then loop through each construct in the set of scope-matched constructs (974) and locate any property template string-matching the construct (976). If the context is not an object (970), then for each construct in the set of scope-matched constructs (980), determine if the construct is an object (982), If not, test the next construct (980). If so, then locate any templates matching the object class (984). Optionally locate any property templates for the object (986). This step may be restricted or eliminated depending on the number of templates for properties or behavioral properties associated with the object type. If including the templates would make the suggestion list 170 unwieldy, then the property templates suggested could be eliminated or reduced, allowing for prioritization of particular templates based on user settings.

Any templates located for object contexts or object constructs will be processed further (988). If there is a limitation for a template based on context, then if the context is matched appropriately (990), customize the template according to the associated construct (992) and add the customized template to the list 170 (994). If the context doesn't match (990) proceed to 988 to test the next template. When all located templates have been processed, proceed to refine the list (248), as described above with respect to FIG. 2A. Then the process terminates.

FIGS. 10A-D include various pseudocode snippets illustrating source code 120 with associated auto-suggestions to illustrate scope-matching and list generation using the example of FIG. 9. Each snippet has a type Person defined in line 1 containing elements name, rule, location and locationrule (lines 2-5). In FIG. 10A, p1 and p2 are declared as objects of type Person (line 7). Elements p1.rule and p2.location are defined in lines 9-10. In line 12, token 114 is being entered, “loca”, with context 112, object p1, indicating that token 114 is an object element. In this example, there are five constructs shown that string-match (e.g. regex) with token 114 (scope-matched names 140). Those that are selected by list generation 230 are displayed as list 170. Here the first two list entries, location and locationrule, were selected as elements of type Person (condition 911). On line 9, “assert (p1.location)” is an assignment expression containing the matching construct, location. However, because the element, p1.rule, while having a matching object type, does not string match with the token, it is eliminated from the list (condition 914). In line 10, the element location is an element of matching type person, so it is included in the list, along with its associated statement, which is an assignment expression, location=“location111” (condition 913). The construct location111 would have been added to the list except that it was already added in a statement enclosing it (condition 912).

FIG. 10B illustrates a snippet identical to 10A except that in line 10 the element p2.rule has replaced p2.location. Therefore, as “rule” does not string match with the token, the expression comprising construct location111 is not included (condition 914), in contrast to the list 170 of FIG. 10A.

FIG. 10C is the same as 10B, except the context has changed. The token is being added after the “=” so it is now the right-hand side of an assignment. This is not a defined context in FIG. 9, nor is it a defined construct, so the default action is taken (242) and the scope-matched construct, “location111” is added to the list.

FIG. 10D illustrates how scope affects list generation. In this example, visibility scope is defined using the programming-language based scope, as determined in syntactical and semantic analysis and AST generation. Here the objects p1 and p2 of type person are instantiated (line 12) in a function foo (line 11). Token “loca” is being entered in context of Person type object p1 (line 16). The generated list 170 appears in lines 17-20. As before, location and locationrule are included. They are in the global scope, accessible throughout source code 120, string match the token, and are included based on condition 911 for the object context.

The two location constructs found on lines 13 and 14 are also within function scope, and therefore the visibility scope of the token. Both also string match the token, so are included in the set of scope-matched constructs 140 and are evaluated for inclusion. The first is excluded, as discussed in FIG. 10A, under condition 914 since “rule” does not string match “loca”. The second, p2.location, context and string matches the token, so location=“some_random_string” is included in the list (913).

Person object p3 is instantiated (line 8) in the scope of procedure fooExternal (line 7). This scope of procedure fooExternal is within the outer scope of function foo, so is therefore within the visibility scope of the token. As such, location=“location333” is included in the list, as it is an assignment expression matching context (913) within the visibility scope.

Person object p4 is instantiated (line 23) in the scope of procedure fooInternal (line 22). This scope of procedure fooInternal is within the inner scope of function foo, so is therefore outside the visibility scope of the token. While the constructs p2.location and “location111” would string match with the token, they are outside of its visibility scope so are not included in the set of scope-matched construct names 140. As such, location=“location111” is excluded from the list.

The subprocesses of FIG. 9 and the examples of FIG. 10 are illustrative only. Various other options may be added or substituted, and an embodiment may be configured with parameters to modify the various behaviors in accordance with user preference. For example, an element may have the same name in multiple object types, e.g. location being used in more than one type, and the list generator can be configured to find and list assignments for, e.g. location, associated with any of them. Note also that multi-level context is supported, such as “function(object.token”, e.g. “update(P1.Loca”, where context identifies a function operating on an object. Additional subprocesses may be included in flowchart 230 to provide alternate or additional actions for any multi-level contexts requiring alternate processing.

FIGS. 10E-G include various pseudocode snippets illustrating source code 120 with associated reminder prompts. The techniques of FIG. 9 can be adapted to produce the reminder prompts, as illustrated by the modification of flowchart 200 shown in FIG. 2C.

FIG. 10E illustrates a reminder prompt including a User Defined Behavioral Property (UDBP). Lines 1-3 define Person as a Type having a first type element, Age, which is a number (line 2). Person has a User Defined Behavioral Property (UDBP) shown in line 3. The “Person” represents a type identifier, and “Age” represents a type element identifier. The UDBP is identified by “!” symbol. In this example, the UDBP asserts a value based on the evaluation of an expression, e.g. “assert (person.age>60)” as shown in the right hand side. The value asserted by the UDBP can vary, as detailed above. The value is assigned to the “SeniorCitizen” in the left hand side. A variable p1 of type Person is declared on line 5. The type element identifier and property related information are stored in a data structure.

When a programmer types in a token, e.g. “p1.age” (line 7), p1 provides type context and age string-matches age, therefore referencing the type element “person.age” which is used in the UDBP expression. In response, the IDE provides a reminder prompt 1002 of the UDBP, “>>>>!Seniorcitizen: assert (person.age>60),” to remind the programmer that there is a UDBP involving “person.age”. The token entered in the source code editor is matched with the type element identifier. The property related information associated with the type element identifier is retrieved from the data structure and then displayed as a reminder prompt linked to the token. Note that in this embodiment this prompt serves as a reminder or information to the programmer and does not incorporate autocomplete functionality. There can be more than one UDBPs within a type, and an element, such as person.age, may be incorporated in multiple UDBPs. A reminder prompt list is generated including multiple UDBPs, when applicable, involving the type element, e.g. person.age. The IDE uses a different user interface representation (e.g. coloring, font, border, separation-line, and the like) for the reminder prompt to distinguish it from an autocomplete suggestion, examples of which were shown in FIGS. 10A-D. This is illustrated by “>>>>” instead of “>>” in these examples.

FIG. 10F illustrates a reminder prompt including a computed property. Lines 1-3 define Person as a Type having a first type element, Dob, which is a date (line 2). Person has a computed property, Age, shown in line 3, which involves the type element person.dob. Age, representing a property identifier, is computed using the expression on the right hand side of the computed property, @now—person.dob, which is the difference between the current date (represented by @now) and the person's date of birth. The property identifier and property related information are stored in the data structure. A variable p1 of type Person is declared on line 5. When a programmer types in a token, e.g. “p1.age” (line 7), it references the type element “person.age”, as described above. In response, the IDE provides a reminder prompt 1004, “>>>>Age: @now—person.dob,” to remind the programmer that there is a computed property involving “person.age”. Here, person.age is the computed property. The token entered in the source code editor is matched with the property identifier. The property related information associated with the property identifier is retrieved from the data structure and then displayed as a reminder prompt linked to the token. Again, in this embodiment, this prompt serves as a reminder or information to the programmer and does not incorporate autocomplete functionality.

FIG. 10G illustrates a reminder prompt including a computed property dependent on a type element. Lines 1-3 define Person as in FIG. 10F. A variable p1 of type Person is declared on line 5. When a programmer types in “p1.dob” (line 7), it references the type element “person.dob.” the IDE provides a reminder prompt 1006, “>>>>Age: @now-person.dob,” to remind the programmer that there is a computed property involving “person.dob”. Here, the same computed property is displayed in the reminder prompt, but this time it is in response to the type element used in the computed property expression. Again, in this embodiment, this prompt serves as a reminder or information to the programmer and does not incorporate autocomplete functionality.

FIG. 11 illustrates a local IDE environment 106 interacting with project server 1190 in a distributed IDE environment. Source code for a project is maintained and synchronized across the local IDEs participating in the project. An IDE (either locally or centrally at the project server) generates a data structure which tracks the syntax structure and semantic model of the source code, the data structure used in providing scope-matched autosuggestion, accommodating distributed updating of the source code by a plurality of users.

User 102 via user terminal 104 enters credentials into secure login 1102 to begin an IDE session 106. The IDE session begins with IDE session initializer 1104, which triggers active session replicator 1106 to interface with the active session manager 1195, a component of project server 1190. Active session manager 1195 maintains active sessions 1130a-1130n for each of N users. This allows any logged in user to access the state of their session from any device, and keep that state synchronized between one or more devices. A user can remain logged in to the project server and that user's state will be retained. When a user logs out completely that active session can be removed. In general, the session initializer is responsible for setting up a new session when a developer starts working in the IDE. The session replicator 1106 ensures that the session state is consistently replicated across multiple environments or users. It is especially useful in collaborative development, remote coding, or multi-device synchronization. In collaborative or cloud-based IDEs, the session initializer 1104 retrieves the last known session state, and the session replicator 1106 keeps it updated in real time. An example collaborative coding scenario is when a developer joins a live coding session, the session initializer 1104 sets up their IDE with the current project state and the session replicator 1106 ensures that changes made by one developer are instantly visible to other developers in the session. An example device switching scenario is when a developer moves from their office desktop to a laptop. The session initializer 1104 loads the last session state, and the session replicator 1106 syncs any ongoing changes, ensuring the developer can continue working seamlessly.

Upon initialization, the session user association module 1150 determines whether an active session exists for the user. If so, then the active session 1130 data is delivered to the active session replicator 1106. If one does not exist then session state synchronizer 1155 retrieves project specific data and user specific data to create an active session and delivers it to active session replicator 1106. In either case, the data is used to populate the local IDE environment 106. Here, active session 1130a for User 1 comprises project level data including source code 1135a, workflows 1136a, and operations 1137a. These are kept synchronized with those of other users via open active sessions, as well as with project server 1190. Source code 1135a includes source code 125 and can include code templates 640. It can also include a copy of abstract syntax tree 400, although that can also be regenerated by the local compiler in IDE 106. Permissions specific to User 1 are supplied from permissions 1182 as User 1 permissions 1134a.

Active session manager can use a communication specification such as Publish-Subscribe (Pub/Sub) or REST API. In a Pub/Sub system, messages are published to a topic by a publisher, and any number of subscribers can receive those messages by subscribing to that topic. The system decouples the publisher of a message from its subscribers in time and space, providing a flexible, scalable, and dynamic messaging infrastructure. Messaging is asynchronous, so publishers can continue processing without waiting for subscribers to receive messages, enhancing system efficiency and responsiveness. They can easily scale to accommodate a large number of publishers and subscribers, as well as a high volume of messages. These and other features make Pub/Sub systems ideal for a wide range of applications, from real-time data distribution and microservices architectures to event-driven workflows and message broadcasting, and well suit active session management, including synchronizing state and data, between a project server 1190 and various user terminals 104.

A variety of state elements are captured and stored in the User 1.obj file 1133a. In the context of session management, a Session Object File, or .obj, may be a serialized object or data structure used by an active session manager to store session data temporarily. Active session managers handle the lifecycle of user sessions in an application, including creation, maintenance, and termination of sessions. The “.obj” file in this scenario could be a file format or naming convention used to store session-specific data on the server side, such as user preferences, authentication tokens, or other temporary state information. This session data maintains the state of an interaction between a client and a server, especially in stateless protocols like HTTP where each request is independent of the last. By managing session data, applications can provide a personalized and cohesive experience to users across multiple requests and interactions.

A code mask (1) 1132a is included which, along with source code 1135a, allows the IDE to manage the source code visible to the user in accordance with any permission requirements and the user's permission levels. In one embodiment, source code 1135a with visibility permission requirements may be encrypted with decryption accessibility only available to the compiler for compiling and to users with the appropriate permission level settings. Source code masking and/or encryption may be executed in source code masker 1164 to provide the user level source codes 1135 and masks 1132 for the various user sessions 1130.

Permissions are set by one or more users with permission clearance to do so, such as project managers or technical leads. When a user 102 has such clearance, he or she can access dashboard 1111 via IDE user interface 1120 and set permissions for users and/or groups. Various permission schemes and hierarchies can be deployed in accordance with IDE design specifications as well as tailoring to the needs of particular organizations and projects. Dashboard 1111 interfaces with project server 1190 via permission validator 1160, which has access to the project team structures & roles 1166, which in this example includes users 1168 (e.g. a SQL server) and groups & roles 1170 (e.g. an LDAP server). The permissions are stored in permissions 1182 and made available to the user permissions 1134 in the active sessions 1130 via permission mapper 1162.

SQL (Structured Query Language) servers are database servers that use SQL as the primary language to manage and manipulate relational databases. SQL is a standard programming language specifically designed for storing, manipulating, and retrieving data in databases. SQL servers are widely used due to their efficient handling of structured data, transactions, and complex queries. Examples of SQL database management systems include Microsoft SQL Server, MySQL, PostgreSQL, and Oracle Database. LDAP (Lightweight Directory Access Protocol) servers are protocol-based servers that manage and access directory information services over an IP network. LDAP is used for storing organizational information and providing directory services, such as email addresses, usernames, and group memberships. It is optimized for reading, searching, and browsing rather than writing or updating data, making it ideal for quick lookup and authentication services. Examples of LDAP implementations include Microsoft Active Directory, OpenLDAP, and Apache Directory Server.

Active session replicator 1106 populates the IDE environment 106 state upon session initialization and synchronizes with the project server 1190 as appropriate. In this example the local session includes abstract syntax tree 1140, permissions 1142, operations 1144, workflows 1146, and code templates 1148. The user operates on source code 1115 via IDE user interface 1120 and one or more source code editors 110 as well as with the local IDE compiler. As edits are made, AST update 1124 (optionally using the functions of the local compiler) maintains and updates AST 1140. Those edits made via other users are also updated via synchronization with active session replicator 1106 and active session manager 1195.

When a user is active developing source code in IDE 106, any number of IDE trigger activities are captured via IDE user interface 1120 within one or more source code editor windows managed by source code editors 110. These are typically visible in one or more windows on one or more displays 1108.

IDE-captured trigger activities are managed with operation validator 1110, which has access to the project specific operations 1144, workflows 1146, and code templates 1148. The permission requirements for various operations are available in AST 1140 (or any other set of data structures, as described above). For each operation, if a permission is required, the appropriate permission is checked, and the appropriate workflow is retrieved and carried out. In one example, an IDE trigger occurs when a user types a particular construct or partial construct that invokes an workflow incorporating an autosuggestion display, including one or more of the various aspects disclosed herein.

A workflow is a predefined sequence of tasks or actions that automate and streamline processes to achieve specific goals. It defines the logical flow of actions, decisions, and conditions within a system. A trigger is an event or condition that initiates a workflow, serving as the catalyst for automated processes.

Configuring a workflow involves designing the sequence of tasks, actions, and decisions. This process may be carried out by individuals or teams with expertise in process design, automation, and a specific workflow tool being used. In the context of a software development scenario, an IDE may be configured such that a trigger might be set up to automatically alert a project leader based on specific conditions, such as using code not conforming with defined best practices code for the project. The project leader plays an important role in configuring and overseeing the workflow to ensure efficient and consistent task execution.

A trigger in the IDE may include any input from a user, examples include text editing, mouse/trackpad inputs, voice commands, and the like. Various IDE trigger operations associated with source code include viewing, adding, and editing source code, as well as interacting with an IDE by, e.g., accepting or rejecting autocomplete or autosuggestion code or code templates. As this is a distributed IDE, results from triggers and workflows from a plurality of distributed users are collected and maintained to provide common code, project databases, parameters, code templates, and the like, and are synchronized across the individual IDE components within the distributed IDE.

A class of objects may be identified by properties that are inherent in the programming language or may be user defined, for which code templates may be defined. Object properties and user-defined functions may have associated code templates. Code templates 1148 for all of these can be defined, stored, retrieved, and customized for insertion into an autosuggest module, as defined by one or more workflows 1146.

In FIG. 1, an example setting 190 enabled link-type criteria code templates for autosuggestion. Example link-type criteria includes determining the existence of an IDT object, determining whether a dependency such as a DDT object exists, and evaluation of constraints specific to an object management function (e.g., create, update, or delete) or specific to a link object type (e.g., IDT or DDT). Link-type criteria can be evaluated in different phases. For example, an event handler may be used to evaluate criteria prior to an object management function execution, like determining whether an IDT object exists prior to creating an object dependent on that object.

Dashboard 1111 can be used to enable or disable one or more types of code templates for use in autosuggestion and can be used to allow a variety of user-defined settings, as detailed throughout. Preferences or parameters for use in refining the list generation may be included here. Dashboard 1111 also may include areas to set permissions, as well as various other parameters of the IDE. As described with respect to FIG. 1, switch 190 can be used for a specific purpose, such as enabling or disabling link-type criteria templates. Alternatively, switch 190 may be used to activate dashboard 1111 to access any number of settings, including those for various types of code templates available for autosuggestion.

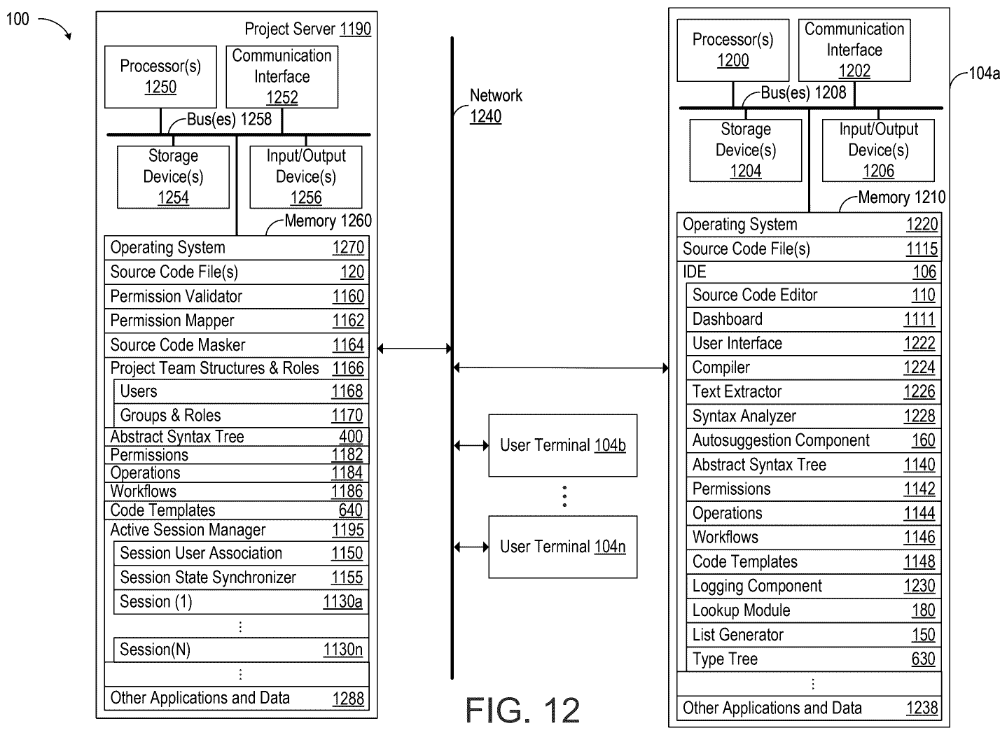

FIG. 12 illustrates an example embodiment of distributed IDE 100 including components of a user terminal 104 and a project server 1190. Here user terminal 104a is connected via network 1240 with other user terminals 104b-n and a project server 1190. However, it should be noted that the IDE operating environment and the aspects disclosed herein are not constrained to any particular configuration of devices.

User terminals 104a-n may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IOT) device, a distributed computing system, multiprocessor systems, or combination thereof. A user terminal may be configured utilizing a cloud service. The operating environment of IDE 100 may be configured in a network environment, a distributed environment, a multi-processor environment, or a stand-alone computing device having access to remote or local storage devices.

User terminals 104 may include one or more processors 1200, a communication interface 1202, one or more storage devices 1204, one or more input/output devices 1206, and a memory 1210. A processor 1200 may be any commercially available or customized processor and may include multi-processor architectures. The communication interface 1202 facilitates wired or wireless communications between the computing devices such as user terminals 104, project server 1190, and other devices. The components of a user terminal 104 are communicatively coupled via one or more buses 1208.

A storage device 1204 may be a computer-readable medium that does not contain propagating signals, such as modulated data signals transmitted through a carrier wave. Examples of a storage device 1204 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1204 in the computing devices 104. The input/output devices 1206 may include a keyboard, mouse, pen, voice input device, touch input device, display, speakers, printers, etc., and any combination thereof.

A memory 1210 may be any non-transitory computer-readable storage media that may store executable procedures, applications, and data. Various of these components and data are detailed above, e.g. with respect to FIGS. 1, 6 and 11. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. A memory 1210 may also include one or more external storage devices or remotely located storage devices.

The memory 1210 may contain instructions, components, and data. A component is a software program that performs a specific function and is otherwise known as a module, program, and/or application. The memory 1210 may include an operating system 1220, one or more source code files 1115, an IDE 106 and other applications and data 1238. IDE 106 may include a source code editor 110, a dashboard 1111, a user interface 1222, a compiler 1224, a text extractor 1226, a syntax analyzer 1228, an autosuggestion component 160, an abstract syntax tree 1140, permissions 1142, operations 1144, workflows 1146, code templates 1148, and a logging component 1230. As detailed above, autosuggestion 160 may be supported by lookup module 180, list generator 150, and type tree 630.

User terminal 104 may utilize an integrated development environment (IDE) 106 that allows a user (e.g., developer, programmer, designer, coder, etc.) to design, code, compile, test, run, edit, debug, or build a program, set of programs, web sites, web applications, and web services in a computer system. Software programs can include source code files 1115, created in one or more source code languages (e.g., Visual Basic, Visual J #, C++. C#, J #, Java Script, APL, COBOL, Pascal, Eiffel, Haskell, ML, Oberon, Perl, Python, Scheme, Smalltalk and the like, as well as proprietary or custom-designed programming languages). The IDE 106 may provide a native code development environment or may provide a managed code development that runs on a virtual machine or may provide a combination thereof. The IDE 106 may provide a managed code development environment using a framework such as Java SE, .NET, Node.js, Python Frameworks such as Django, Flask, etc., Ruby on Rails, PHP Frameworks such as Laravel, Symfony, etc., React, and others. It should be noted that this operating environment embodiment is not constrained to providing the source code development services through an IDE and that other tools may be utilized instead, such as a stand-alone source code editor and the like.

A user can create and/or edit the source code files 1115 according to known software programming techniques and the specific logical and syntactical rules associated with a particular source language via a user interface 1222 and a source code editor 110 in the IDE 106. Thereafter, the source code files 1115 can be compiled via a compiler 1224, such as a front end or language compiler. During this compilation process, the front-end of compiler 1224 generates data structures representing the syntactic structure and semantic model of the source code.

Project server 1190 may be any type of electronic device, including without limitation those detailed for user terminals 104. A project server may be configured utilizing a cloud service. A project server 1190 may include one or more processors 1250, a communication interface 1252, one or more storage devices 1254, one or more input/output devices 1256, and a memory 1260. A processor 1250 may be any commercially available or customized processor and may include multi-processor architectures. The communication interface 1252 facilitates wired or wireless communications between the computing devices such as user terminals 104 and other devices. The components of a project server 1190 are communicatively coupled via one or more buses 1258.

A storage device 1254 may be a computer-readable medium that does not contain propagating signals, such as modulated data signals transmitted through a carrier wave. Examples of a storage device 1254 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1254 in the project server 1190. The input/output devices 1256 may include a keyboard, mouse, pen, voice input device, touch input device, display, speakers, printers, etc., and any combination thereof.

A memory 1260 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc., A memory 1260 may also include one or more external storage devices or remotely located storage devices.

The memory 1260 may contain instructions, components, and data. Various of these components and data are detailed above, e.g. with respect to FIG. 11. The memory 1260 may include an operating system 1270, one or more source code files 120, and other applications and data 1288. Permission validator 1160 works with permission mapper 1162 and project team structures and roles 1166, which comprises users database 1168 and groups & roles database 1170. Project server 1190 also comprises source code masker 1164, abstract syntax tree 400, permissions 1182, operations 1184, workflows 1186, and code templates 640. Active session manager 1195 maintains and synchronizes sessions 1-N 1130a-n via session user association 1150 and session state synchronizer 1155. Other modules may be included in project server 1190.

The user terminals 104 and project server 1190 may be communicatively coupled via network 1240. The network 1240 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 1240 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

1. A method comprising:
generating a data structure that tracks a syntax structure and semantic model of a source code program comprising a plurality of program constructs, the data structure comprising a plurality of scopes, each scope associated with one or more locations within the source code program;
encountering a token entered in a source code editor at a first of the one or more locations;
identifying a set of scope constructs, the set of scope constructs identified from the plurality of program constructs, including in the set of scope constructs program constructs within the scope associated with the first location and excluding program constructs outside the scope associated with the first location;
comparing the token to each of the set of scope constructs;
selecting a set of scope-matched constructs, the set of scope-matched constructs selected from the set of scope constructs responsive to the token string-matching the scope construct;
generating a list of auto-suggestion candidates, each auto-suggestion candidate comprising one or more of the scope-matched constructs; and
displaying the list of auto-suggestion candidates.

2. The method of claim 1, further comprising updating the data structure responsive to updates in the source code program entered by a plurality of users in a distributed integrated development environment.

3. The method of claim 1, wherein the source code program is contained in two or more source code files.

4. The method of claim 1, wherein the token has a context, the method further comprising:
determining whether the context comprises a first object of a type;
determining whether one of the set of scope-matched constructs is an element of the type responsive to the context comprising the first object of the type;
identifying a statement comprising an assignment to the element of the type; and
adding the assignment to the element of the type to the list of auto-suggestion candidates.

5. The method of claim 1, wherein the token has a context, the method further comprising:
determining whether the context comprises a first object of a type;
determining whether one of the set of scope-matched constructs is an element of the type responsive to the context comprising the first object of the type; and
disregarding the one of the set of scope-matched constructs in the list of auto-suggestion candidates responsive to it not being an element of the type.

6. A method operable with source code having a plurality of location identifiers, each location identifier associated with one of a plurality of locations in the source code, and a plurality of constructs, each having a construct name and a construct location corresponding to one of the locations in the source code, the method comprising:
identifying a plurality of regions within the source code, each region defined by a first and a second region boundary selected from the plurality of location identifiers, wherein a location between the first and second region boundaries is defined to be within the region;
defining a visibility scope for each of the plurality of regions, each visibility scope comprising one or more of the regions, wherein a location within any of the one or more regions of the visibility scope is defined to be within the visibility scope;
encountering in a source code editor a token comprising one or more characters having a token location corresponding to the location within the source code where the token is to be inserted;
selecting a set of scope-matched names from the plurality of construct names, each scope-matched name selected responsive to the construct name string-matching the token and having a construct location within the visibility scope of the region containing the token location;
generating a set of one or more list elements, each list element comprising one or more of the selected scope-matched names; and
displaying the set of list elements in the source code editor.

7. The method of claim 6, further comprising:
encountering an additional character added to the token;
reselecting the set of scope-matched names from the plurality of construct names, each scope-matched name selected responsive to the construct name string-matching the token and having a construct location within the visibility scope of the region containing the token location;
regenerating the set of list elements, each list element comprising one or more of the selected scope-matched names; and
displaying the set of list elements in the source code editor.

8. The method of claim 6, further comprising:
encountering a selection of one of the list elements; and
replacing the token with the selected list element responsive to the selection.

9. The method of claim 8, further comprising:
identifying a subset of the plurality of regions within the source code whose locations are affected by the insertion of the selected list element into the source code; and
updating the first and second region boundaries of each region within the identified subset of the plurality of regions responsive to the insertion of the selected list element into the source code.

10. The method of claim 6, further comprising:
encountering a scope-delimiting construct entered into the source code editor;
adding an additional region defined by a first and second region boundary to the plurality of regions within the source code; and
defining a visibility scope for the additional region.

11. A system comprising:
a processing unit configured to receive source code in one or more source code files;
a parser module in communication with the processing unit, configured to parse the received source code files and identify constructs within the source code;
a source code editor having:
a code input module configured to accept a sequence of characters being input by a user; and
a location determination module configured to determine a current input location within the source code where the sequence of characters are being input; and
a lookup module in communication with the source code editor, configured to:
identify constructs that are in the scope of the current input location, based on the current input location and the structure of the surrounding code,
compare the identified constructs with the sequence of characters, and
generate a list of scope-matched constructs that are available for use within the scope of the current input location and match the sequence of characters in whole or in part.

12. The system of claim 11, further comprising an output module configured to display the list of scope-matched constructs to the user in real-time as the sequence of characters are being input.

13. The system of claim 11, wherein the lookup module is further configured to form a regular expression using the sequence of characters, the regular expression for use in comparing with the identified constructs.

14. The system of claim 11, wherein the source code editor further comprises an auto-completion module configured to complete the inputted sequence of characters responsive to a selection of the scope-matched constructs listed.

15. The system of claim 11, wherein the scope-matched constructs identified are limited to those that are contextually relevant to the sequence of characters being entered.

16. The system of claim 15, wherein contextual relevance includes, when a first object is associated with the sequence of characters and a second object is associated with the scope-matched construct, the first object and second object being defined by the same type.

17. The system of claim 15, wherein contextual relevance includes, when a first function is associated with the sequence of characters and a second function is associated with the scope-matched construct, the first and second functions being the same.

18. The system of claim 15, wherein contextual relevance includes, when context of the sequence of characters indicates it is an element of an object defined by a type, the scope-matched construct is an element of the type.

19. The system of claim 12, wherein the sequence of characters has a context, further comprising
a set of source code templates; and
wherein the processing unit is further configured to:
select a source code template associated with the context and one of the scope-matched constructs; and
adapt the source code template with the associated scope-matched construct;
and wherein the output module is further configured to display the adapted source code template.

20. The system of claim 12, further comprising a user interface configured to receive a user selection of one of the listed constructs for insertion into the source code.

21. The system of claim 11, wherein the location determination module and lookup module are configured to update the list of scope-matched constructs in real-time as the user continues to input characters to the sequence of characters, dynamically refining the list based on the continued input.

22. A system comprising:
one or more processors coupled to a memory; and
one or more programs, wherein the one or more programs are stored in the memory and configured to be executed by the one or more processors, the one or more programs including instructions that:
generate a data structure that tracks a syntax structure and semantic model of a source code program having a plurality of program constructs, the data structure comprising a plurality of scopes, each scope associated with one or more locations within the source code program;
encounter a token entered in a source code editor at a first of the one or more locations;
identify a set of scope constructs, the set of scope constructs identified from the plurality of program constructs, including in the set of scope constructs program constructs within with the scope associated with the first location and excluding program constructs outside the scope associated with the first location;
compare the token to each of the set of scope constructs;
select a set of scope-matched constructs, the set of scope-matched constructs selected from the set of scope constructs responsive to the token string-matching the scope construct;
generate a list of auto-suggestion candidates, each auto-suggestion candidate comprising one or more of the scope-matched constructs; and
display the list of auto-suggestion candidates.

23-52. (canceled)
